(19) United States
(12) Patent Application Publication
(10) Pub. No.: US 2014/0173449 A1
(43) Pub. Date: Jun. 19, 2014

(54) Methods, Systems, and Computer Program Products for Processing a Request Via a Communications Agent

(71) Applicant: DEEP RIVER VENTURES, LLC, Raleigh, NC (US)

(72) Inventor: Robert Paul Morris, Raleigh, NC (US)

(73) Assignee: DEEP RIVER VENTURES, LLC, Raleigh, NC (US)

(21) Appl. No.: 13/716,158

(22) Filed: Dec. 16, 2012

(51) Int. Cl. H04L 29/08; G06F 3/0484

(52) U.S. Cl. CPC H04L 67/32; G06F 3/0484
USPC 715/738; 709/217

(57) ABSTRACT

Methods and systems are described for processing a request via a communications agent. In an aspect, a request is identified by a communications agent in an execution environment. A communications request identifying the request is sent in a communication for processing by a web service. The requesting execution environment receives a communications response identifying a communications result that differs from a web result received in response to a web request identifying the request sent to the web service. In another aspect, a communications request is received in a communication by a communications. A request identified by the communications request is identified to a web service. A communication result is received that differs from a web result generated when the web service receives the request in a web request from a user agent. A communications response identifying the communications result is sent in response to receiving the communications request.

### RELATED APPLICATIONS

This application is related to the following commonly owned U.S. patent applications: application Ser. No. 13/716,156 (Docket No DRV0018) filed on 2012 Dec. 16, entitled “Methods, Systems, and Program Products for Processing a Search Query Via a Communications Protocol”;

application Ser. No. 13/716,159 (Docket No DRV0023) filed on 2012 Dec. 16, entitled “Methods, Systems, and Program Products for Browsing Via a Communications Agent”;

application Ser. No. 13/716,160 (Docket No DRV0024) filed on 2012 Dec. 16, entitled “Methods, Systems, and Program Products for Accessing a Service Via a Proxy Communications Agent”;

application Ser. No. 13/624,906 (Docket No DRV00019) filed on 2012 Sep. 22, entitled “Methods, Systems, and Program Products for Processing a Data Object Request in a Communication”;

application Ser. No. 13/626,635 (Docket No DRV0010) filed on 2012 Sep. 25, entitled “Methods, Systems, and Program Products for Sharing a Data Object in a Data Store Via a Communication”;

application Ser. No. 13/647,144 (Docket No DRV0006) filed on 2012 Oct. 8, entitled “Methods, Systems, and Program Products for Exchanging Presentation Data in a Communication”;

application Ser. No. 13/624,940 (Docket No DRV0011) filed on 2012 Sep. 23, entitled “Methods, Systems, and Program Products for Processing a Reference in a Communication to a Remote Data Object”; and

application Ser. No. 13/654,467 (Docket No DRV0012) filed on 2012 Oct. 18, entitled “Methods, Systems, and Program Products for Constraining a Data Exchange Request in a Communication”.

### BACKGROUND

Many users spend much of their time in using computing device in interacting with communications applications or communications agents, such a voice agents, email agents, instant messaging agents, and multi-media communications agents that allow communication via video, still images, audio, and/or text. To access documents and/or web content users must leave their communications agents to access other applications which are not well integrated with communications agents. Further, access to network resources including data and services may vary depending on whether a user is connected to a work intranet, a home network, a wireless network of a wireless voice and Internet service provider. Due to the importance of user communication, communications agents have access to data and services not accessible via web browsers. Integration of network capabilities such as service applications via the Internet and/or via an intranet would allow user's access to data and services not accessible via current web services, allow users' to remain engaged with their communications agents, and provide new capabilities as described herein.

Accordingly, there exists a need for methods, systems, and computer program products for processing a request via a communications agent.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for processing a request via a communications agent. In one aspect, the method includes receiving, from a requesting communicant by a requesting communications agent operating in a requesting execution environment, request information that identifies a first request. The method further includes sending, by the requesting communications agent via a network in a communication, a communications request, that identifies the first request for processing by a web service. The method still further includes receiving, by the requesting execution environment, in response to sending the communications request, a communications response that identifies a communications result, wherein the communications result differs from a web result received in a web response generated in response to a web request that identifies the first request when the web request is sent by a user agent operating in the requesting execution environment to the web service. Performing at least one the preceding actions comprising the method includes execution of an instruction by a processor.

Also, a system for processing a request via a communications agent is described that includes at least one processor; and logic encoded in at least one data storage media to execute by the at least one processor that when executed is operable for and/or is otherwise included in receiving, from a requesting communicant by a requesting communications agent operating in a requesting execution environment, request information that identifies a first request; sending, by the requesting communications agent via a network in a communication, a communications request, that identifies the first request for processing by a web service; and receiving, by the requesting execution environment, in response to sending the communications request, a communications response that identifies a communications result, wherein the communications result differs from a web result received in a web response generated in response to a web request that identifies the first request when the web request is sent by a user agent operating in the requesting execution environment to the web service.

Further, a system for processing a request via a communications agent is described. The system includes a processor that executes an instruction included in at least one of a request agent component, a com-out component, and a response director component during operation of the system. During operation of the system the request agent component is operable for and/or is otherwise included in receiving, from a requesting communicant by a requesting communications agent operating in a requesting execution environment, request information that identifies a first request; the com-out component is operable for and/or is otherwise included in sending, by the requesting communications agent via a network in a communication, a communications request, that identifies the first request for processing by a web service; and the response director component is operable for and/or is otherwise included in receiving, by the requesting execution environment, in response to sending the communications request, a communications response that identifies a communications result, wherein the communications result differs from a web result received in a web response generated in response to a web request that identifies the first request when the web request is sent by a user agent operating in the requesting execution environment to the web service.

In another aspect, a method includes receiving, in a communication by a communications relay via a network from a communications agent representing a requesting communicant and operating in a requesting execution environment, a communications request. The method further includes identifying, in processing the communications request, a service request to a web service. The method still further includes receiving a communications result in response to sending the service request, wherein the communications result differs from a web result generated when the web service receives the service request in a web request from a user agent operating in the requesting execution environment. The method additionally includes sending, via the network to the requesting execution environment in response to receiving the communications request, a communications response that identifies the communications result. Performing at least one the preceding actions comprising the method includes execution of an instruction by a processor.

Also, a system for processing a request via a communications agent is described that includes at least one processor; and logic encoded in at least one data storage media to execute by the at least one processor that when executed is operable for and/or is otherwise included in receiving, in a communication by a communications relay via a network from a communications agent representing a requesting communicant and operating in a requesting execution environment, a communications request; identifying, in processing the communications request, a service request to a web service; receiving a communications result in response to sending the service request, wherein the communications result differs from a web result generated when the web service receives the service request in a web request from a user agent operating in the requesting execution environment; and sending, via the network to the requesting execution environment in response to receiving the communications request, a communications response that identifies the communications result.

Further, a system for processing a request via a communications agent is described. The system includes a processor that executes an instruction included in at least one of a request-in component, a request gateway component, a response-in component, and a response gateway component during operation of the system. During operation of the system the request-in component is operable for and/or is otherwise included in receiving, in a communication by a communications relay via a network from a communications agent representing a requesting communicant and operating in a requesting execution environment, a communications request; the request gateway component is operable for and/or is otherwise included in identifying, in processing the communications request, a service request to a web service; the response-in component is operable for and/or is otherwise included in receiving a communications result in response to sending the service request, wherein the communications result differs from a web result generated when the web service receives the service request in a web request from a user agent operating in the requesting execution environment; and the response gateway component is operable for and/or is otherwise included in sending, via the network to the requesting execution environment in response to receiving the communications request, a communications response that identifies the communications result.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary execution environment in which the subject matter may be implemented that includes and/or otherwise is provided by a hardware device;

FIG. 2A is a flow diagram illustrating a method for processing a request via a communications agent according to an aspect of the subject matter described herein;

FIG. 2B is a flow diagram illustrating a method for processing a request via a communications agent according to an aspect of the subject matter described herein;

FIG. 3A is a block diagram illustrating an arrangement of components for processing a request via a communications agent according to another aspect of the subject matter described herein;

FIG. 3B is a block diagram illustrating an arrangement of components for processing a request via a communications agent according to another aspect of the subject matter described herein;

FIG. 4A is a block diagram illustrating an arrangement of components for processing a request via a communications agent according to another aspect of the subject matter described herein;

FIG. 4B is a block diagram illustrating an arrangement of components for processing a request via a communications agent according to another aspect of the subject matter described herein;

FIG. 4C is a block diagram illustrating an arrangement of components for processing a request via a communications agent according to another aspect of the subject matter described herein;

FIG. 5 is a network diagram illustrating a system for processing a request via a communications agent according to another aspect of the subject matter described herein;

FIG. 6A is a diagram illustrating a user interface presented via a display according to another aspect of the subject matter described herein;

FIG. 6B is a diagram illustrating a user interface presented via a display according to another aspect of the subject matter described herein;

FIG. 7 is a message flow diagram illustrating an exemplary data and execution flow for processing a request via a communications agent according to an aspect of the subject matter described herein;

FIG. 8A illustrates an exemplary portion of a communication according to an aspect of the subject matter described herein;

FIG. 8B illustrates another exemplary portion of a communication according to an aspect of the subject matter described herein; and

FIG. 8C illustrates another exemplary portion of a communication according to an aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure. It is to be understood that other embodiments and/or aspects may be utilized and structural and functional modifications may be made without departing from the scope of the subject matter disclosed herein.

The use of “including”, “comprising”, “having”, and variations thereof are meant to encompass the items listed thereafter and equivalents thereof as well as additional items and equivalents thereof. Terms used to describe interoperation and/or coupling between components are intended to include both direct and indirect interoperation and/or coupling, unless otherwise indicated. Exemplary terms used in describing interoperation and/or coupling include “mounted,” “connected,” “attached,” “coupled,” “communicatively coupled,” “operatively coupled,” “invoked”, “called”, “provided”, “received”, “identified”, “interoperated” and similar terms and their variants.

As used herein, any reference to an entity “in” an association is equivalent to describing the object as “identified” by the association, unless explicitly indicated otherwise.

Unless otherwise defined, all technical and scientific terms used herein have the same meaning as commonly understood by one of ordinary skill in the art to which this disclosure belongs. Although methods, components, and devices similar or equivalent to those described herein can be used in the practice or testing of the subject matter described herein, suitable methods, components, and devices are described below.

All publications, patent applications, patents, and other references mentioned herein are incorporated by reference in their entirety. In case of conflict, the present disclosure, including definitions, will control. In addition, the materials, methods, and examples are illustrative only and not intended to be limiting.

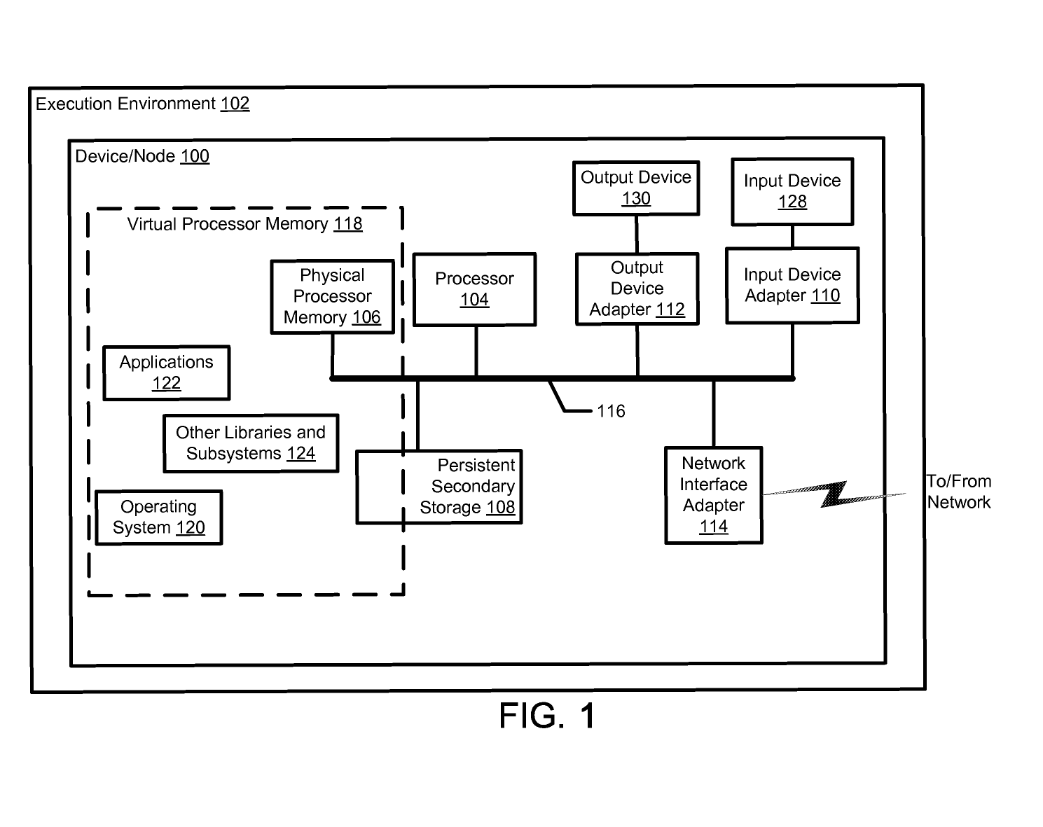

An exemplary device included in an execution environment that may be programmed, adapted, modified, and/or otherwise configured according to the subject matter is illustrated in FIG. 1. An “execution environment”, as used herein, is an arrangement of hardware and, in some aspects, software that may be further modified, transformed, and/or otherwise configured to include and/or otherwise host an arrangement of components to perform a method of the subject matter described herein. An execution environment includes and/or is otherwise provided by one or more devices. The execution environment is said to be the execution environment “of” the device and/or devices. An execution environment may be and/or may include a virtual execution environment including software components operating in a host execution environment. Exemplary devices included in and/or otherwise providing suitable execution environments that may be adapted, programmed, and/or otherwise modified according to the subject matter include a workstation, a desktop computer, a laptop or notebook computer, a server, a handheld computer, a mobile telephone or other portable telecommunication device, a media playing device, a gaming system, a tablet computer, a portable electronic device, a handheld electronic device, a multiprocessor device, a distributed system, a consumer electronic device, a router, a network server, or any other type and/or form of computing, telecommunications or media device that is suitable to perform the subject matter described herein. Those skilled in the art will understand that the components illustrated in FIG. 1 are exemplary and may vary by particular execution environment.

FIG. 1 illustrates a hardware device 100 included in an execution environment 102. FIG. 1 illustrates that execution environment 102 includes a processor 104, such as one or more microprocessors; a physical processor memory 106 including storage locations identified by addresses in a physical memory address space of processor 104; a persistent secondary storage 108, such as one or more hard drives and/or flash storage media; an input device adapter 110, such as a key or keypad hardware, a keyboard adapter, and/or a mouse adapter; an output device adapter 112, such as a display and/or an audio adapter to present information to a user; a network interface component, illustrated by a network interface adapter 114, to communicate via a network such as a LAN and/or WAN; and a mechanism that operatively couples elements 104-114, illustrated as a bus 116. Elements 104-114 may be operatively coupled by various means. Bus 116 may comprise any type of bus architecture, including a memory bus, a peripheral bus, a local bus, and/or a switching fabric.

As used herein a “processor” is an instruction execution machine, apparatus, or device. A processor may include one or more electrical, optical, and/or mechanical components that operate in interpreting and executing program instructions. Exemplary processors include one or more microprocessors, digital signal processors (DSPs), graphics processing units, application-specific integrated circuits (ASICs), optical or photonic processors, and/or field programmable gate arrays (FPGAs). Processor 104 may access instructions and data via one or more memory address spaces in addition to the physical memory address space. A memory address space includes addresses identifying locations in a processor memory. The addresses in a memory address space are included in defining a processor memory. Processor 104 may have more than one processor memory. Thus, processor 104 may have more than one memory address space. Processor 104 may access a location in a processor memory by processing an address identifying the location. The processed address may be identified by an operand of an instruction and/or may be identified by a register and/or other portion of processor 104.

FIG. 1 illustrates a virtual processor memory 118 spanning at least part of physical processor memory 106 and may span at least part of persistent secondary storage 108. Virtual memory addresses in a memory address space may be mapped to physical memory addresses identifying locations in physical processor memory 106. An address space including addresses that identify locations in a virtual processor memory is referred to as a “virtual memory address space”; its addresses are referred to as “virtual memory addresses”; and its processor memory is referred to as a “virtual processor memory” or “virtual memory”. The term “processor memory” may refer to physical processor memory, such as processor memory 106, and/or may refer to virtual processor memory, such as virtual processor memory 118, depending on the context in which the term is used.

Physical processor memory 106 may include various types of memory technologies. Exemplary memory technologies include static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Ferroelectric RAM (FRAM), RAMBUS DRAM (RDRAM) Direct DRAM (DRDRAM), and/or XDR™ DRAM. Physical processor memory 106 may include volatile memory as illustrated in the previous sentence and/or may include non-volatile memory such as non-volatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include a removable data storage medium. The drives and their associated computer readable media provide volatile and/or nonvolatile storage for computer-executable instructions, data structures, program components, and other data.

Execution environment 102 may include software components stored in persistent secondary storage 108, in remote storage accessible via a network, and/or in a processor memory. FIG. 1 illustrates execution environment 102 including an operating system 120, one or more applications 122, and other program code and/or data components illustrated by other libraries and subsystems 124. In an aspect, some or all software components may be stored in locations accessible to processor 104 in a shared memory address space shared by the software components. The software components accessed via the shared memory address space may be stored in a shared processor memory defined by the shared memory address space. In another aspect, a first software component may be stored in one or more locations accessed by processor 104 in a first address space and a second software component may be stored in one or more locations accessed by processor 104 in a second address space. The first software component is stored in a first processor memory defined by the first address space and the second software component is stored in a second processor memory defined by the second address space.

Software components typically include instructions executed by processor 104 in a computing context referred to as a “process”. A process may include one or more “threads”. A “thread” includes a sequence of instructions executed by processor 104 in a computing sub-context of a process. The terms “thread” and “process” may be used interchangeably herein when a process includes only one thread.

Execution environment 102 may receive user-provided information via one or more input devices illustrated by an input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding network interfaces such as a serial port, a parallel port, and/or a universal serial bus (USB) port. Input device adapter 110 may receive input and provide a representation to bus 116 to be received by processor 104, physical processor memory 106, and/or other components included in execution environment 102.

An output device 130 in FIG. 1 exemplifies one or more output devices that may be included in and/or that may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user. Sensory information detected by a user is referred herein to as “sensory input” with respect to the user.

A device included in and/or otherwise providing an execution environment may operate in a networked environment communicating with one or more devices via one or more network interface components. FIG. 1 illustrates network interface adapter (NIA) 114 as a network interface component included in execution environment 102 to operatively couple device 100 to a network. A network interface component includes a network interface hardware (NIH) component and optionally a network interface software (NIS) component.

Exemplary network interface components include network interface controllers, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., AMPS, TDMA, CDMA, GSM, GPRS UMTS, and/or PCS network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component to operatively couple the device to a network. Further, the terms “device” and “node” used herein refer to one or more devices and nodes, respectively, providing and/or otherwise included in an execution environment unless clearly indicated otherwise.

The user-detectable outputs of a user interface are generically referred to herein as “user interface elements” or abbreviated as “UI elements”. More specifically, visual outputs of a user interface are referred to herein as “visual interface elements”. A visual interface element may be a visual output of a graphical user interface (GUI). Exemplary visual interface elements include icons, image data, graphical drawings, font characters, windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes, and radio buttons. An application interface may include one or more of the elements listed. Those skilled in the art will understand that this list is not exhaustive. The terms “visual representation”, “visual output”, and “visual interface element” are used interchangeably in this document. Other types of UI elements include audio outputs referred to as “audio interface elements”, tactile outputs referred to as “tactile interface elements”, and the like.

A “user interface (UI) element handler” component, as the term is used herein, refers to a component that operates to send information representing a program entity to present a user-detectable representation of the program entity by an output device, such as a display. A “program entity” is an object included in and/or otherwise processed by an application or executable. The user-detectable representation is presented based on the sent information. Information that represents a program entity to present a user detectable representation of the program entity by an output device is referred to herein as “presentation information”. Presentation information may include and/or may otherwise identify data in one or more formats. Exemplary formats include image formats such as raw pixel data, JPEG, video formats such as MP4, markup language data such as hypertext markup language (HTML) and other XML-based markup, a bit map, and/or instructions such as those defined by various script languages, byte code, and/or machine code. For example, a web page received by a browser or more generally a user agent from a remote application provider may include HTML, ECMAScript, and/or byte code to present one or more UI elements included in a user interface of the remote application. Components that send information representing one or more program entities to present particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided to store and/or otherwise represent presentation information, which may include audio, visual, tactile, and/or other sensory data for presentation by and/or on an output device. For example, a memory buffer to store an image and/or text string may be a presentation space as sensory information for a user. A presentation space may be physically and/or logically contiguous or non-contiguous. A presentation space may have a virtual as well as a physical representation. A presentation space may include a storage location in a processor memory, secondary storage, a memory of an output adapter device, and/or a storage medium of an output device. A screen of a display, for example, is a presentation space.

An “interaction”, as the term is used herein, refers to any activity including a user and an object where the object is a source of sensory data detected by the user and/or the user is a source of input for the object. An interaction, as indicated, may include the object as a target of input from the user. The input from the user may be provided intentionally or unintentionally by the user. For example, a rock being held in the hand of a user is a target of input, both tactile and energy input, from the user. A portable electronic device is a type of object. In another example, a user looking at a portable electronic device is receiving sensory data from the portable electronic device whether the device is presenting an output via an output device or not. The user manipulating an input component of the portable electronic device exemplifies the device, as an input target, receiving input from the user. Note that the user in providing input is receiving sensory information from the portable electronic. An interaction may include an input from the user that is detected and/or otherwise sensed by the device. An interaction may include sensory information that is received by a user included in the interaction that is presented by an output device included in the interaction.

As used herein “interaction information” refers to any information that identifies an interaction and/or otherwise provides data about an interaction between a user and an object, such as a portable electronic device. Exemplary interaction information may identify a user input for the object, a user-detectable output presented by an output device of the object, a user-detectable attribute of the object, an operation performed by the object in response to a user, an operation performed by the object to present and/or otherwise produce a user-detectable output, and/or a measure of interaction.

Interaction information for one object may include and/or otherwise identify interaction information for another object. For example, a motion detector may detect a user's head turn in the direction of a display of a portable electronic device. Interaction information indicating that the user's head is facing the display may be received and/or used as interaction information for the portable electronic device indicating the user is receiving visual input from the display. The interaction information may serve to indicate a lack of user interaction with one or more other objects in directions from the user different than the detected direction, such as a person approaching the user from behind the user. Thus the interaction information may serve as interaction information for one or more different objects.

As used herein, the terms “program” and “executable” refer to any data representation that may be translated into a set of machine code instructions and may optionally include associated program data. The terms are used interchangeably herein. Program representations other than machine code include object code, byte code, and source code. Object code includes a set of instructions and/or data elements that either are prepared to link prior to loading or are loaded into an execution environment. When in an execution environment, object code may include references resolved by a linker and/or may include one or more unresolved references. The context in which this term is used will make clear the state of the object code when it is relevant. This definition can include machine code and virtual machine code, such as Java™ byte code. A program and/or executable may include one or more components, referred to herein as a “program component”, “software component”, and/or “executable component”. As used herein, the terms “application”, and “service” may be realized in one or more program components and/or in one or more hardware components.

As used herein, the term “network protocol” refers to a set of rules, conventions and/or schemas that govern how nodes exchange information over a network. The set may define, for example, a convention and/or a data structure. The term “network path” as used herein refers to a sequence of nodes in a network that are communicatively coupled to transmit data in one or more data units of a network protocol between a pair of nodes in the network.

A “data unit”, as the term is used herein, is an entity specified according to a network protocol to transmit data between a pair of nodes in a network path to send the data from a source node to a destination node that includes an identified protocol endpoint of the network protocol. A network protocol explicitly and/or implicitly specifies and/or otherwise identifies a schema that defines one or more of a rule for a format for a valid data unit and a vocabulary for content of a valid data unit. One example of a data unit is an Internet Protocol (IP) packet. The Internet Protocol defines rules for formatting an IP packet that defines a header to identify a destination address that identifies a destination node and a payload portion to include a representation of data to be delivered to the identified destination node. Various address types are specified defining a vocabulary for one or more address portions of an IP data unit. The terms “data unit”, “frame”, “data packet”, and “packet” are used interchangeably herein. One or more data units of a first network protocol may transmit a “message” of second network protocol. For example, one or more data units of the IP protocol may include a TCP message. In another example, one or more TCP data units may transmit an HTTP message.

How data is packaged in one more data units for a network protocol may vary as the data traverses a network path from a source node to a destination node. Data may be transmitted in a single data unit between two consecutive nodes in a network path. Additionally, data may be exchanged between a pair of consecutive nodes in several data units each including a portion of the data. Data received in a single data unit by a node in a network path may be split into portions included in several respective data units to transmit to a next node in the network path. Portions of data received in several data units may be combined into a single data unit to transmit by a node in a network path. For purposes of describing the subject matter, a data unit in which data is received by a node is referred to as a different data unit than a data unit in which the data is forwarded by the node.

A “protocol address”, as the term is used herein, for a network protocol is an identifier of a protocol endpoint that may be represented in a data unit of the protocol. For example, 192.168.1.1 is an IP protocol address represented in a human readable format that may be represented in an address portion of an IP header to identify a source and/or a destination IP protocol endpoint. A protocol address differs from a symbolic identifier, defined below, in that a symbolic identifier, with respect to a network protocol, maps to a protocol address. Thus, “www.mynode.com” may be a symbolic identifier for a node in a network when mapped to the protocol address 192.168.1.1. An identifier may be both a symbolic identifier and a protocol address depending on its role with respect to its use for a particular network protocol.

Since a protocol endpoint is included in a node and is accessible via a network via a network interface, a protocol address identifies a node and identifies a network interface of the node. A network interface may include one or more NICs operatively coupled to a network.

Those skilled in the art will understand upon reading the descriptions herein that the subject matter disclosed herein is not restricted to the network protocols described and/or their corresponding OSI layers.

As used herein, the term “communication” refers to data exchanged via a network protocol along with an identifier that identifies a user as a sender of the data and/or as a receiver of the data. The identifier is included in a data unit of the network protocol and/or in a message transported by the network protocol. The network protocol is referred to herein as a “communications protocol”. The sender is referred to herein as a “contactor”. The receiver is referred to herein as a “contactee”. The terms “contactor” and “contactee” identify roles of “communicants” in a communication. The contactor and the contactee are each a “communicant” in the communication. An identifier that identifies a communicant in a communication is referred herein as a “communicant identifier”. The terms “communicant identifier” and “communicant address” are used interchangeably herein. A communicant identifier that identifies a communicant in a communication exchanged via a communications protocol is said to be in an identifier space or an address space of the communications protocol. The data in a communication may include text data, audio data, image data, and/or a program component.

A communications protocol defines one or more rules, conventions, and/or vocabularies for constructing, transmitting, receiving and/or otherwise processing a data unit of and/or a message transported by the communications protocol. Exemplary communications protocols include a simple mail transfer protocol (SMTP), a post office protocol (POP), an instant message (IM) protocol, a short message service (SMS) protocol, a multimedia message service (MMS) protocol, a Voice over IP (VOIP) protocol. Any network protocol that specifies a data unit and/or transports a message addressed with a communicant identifier is or may operate as a communications protocol. In a communication, data may be exchanged via one or more communications protocols. Exemplary communicant identifiers include email addresses, phone numbers, multi-media communicant identifiers such as SKYPE® IDs, instant messaging identifiers, MMS identifiers, and SMS identifiers.

A user in the role of a communicant interacts with a communications agent to receive data addressed to the user in a communication. Alternatively or additionally, a user in the role of a communicant interacts with a communications agent to send data addressed to another communicant in a communication. More generally, the term “communications agent” refers to a component or application that operates in an execution environment to receive, on behalf of a contactee, a communicant message address to the contactee by a communicant identifier in the communication. The communications agent interacts with the contactee communicant in presenting and/or otherwise delivering the communicant message. Alternative or additionally, a communications agent operates in an execution environment to send, on behalf of a contactor, a communicant message in a communication addressed to a contactee by a communicant identifier in the communication. A communications agent that operates on behalf of a communicant in the role of a contactor and/or a contactee as described above is said, herein, to “represent” the communicant.

A “communicant message” data spoken, written, and/or acted by a contactor for a contactee. The data is received by a communications agent representing the contactor and is further received and/or to be received in a communication by a communications agent to present via an output device to the contactee identified in the communication by a communicant identifier. Examples of communicant messages include text written by a contactee in an email and/or an instant message and a spoken message by a contactee included in an audio communication by a VoIP client. To be clear attachments, data unit headers, message headers, communication session control data, and/or connection data for setup and management of a communication are not communicant messages as defined herein.

The term “communicant alias” as used herein refers to an identifier of a communicant in a communication where the communicant alias is not a communicant identifier in an address space of a communication protocol via which the communication is exchanged.

The term “attachment” as used herein refers to data, that is not a communicant message, exchanged in a communication from a sending communications agent and/or communications service to a recipient communications agent and/or communications service. An attachment may be, for example, a copy of a file stored and/or otherwise represented in a file system and/or in another data store in an execution environment that includes a communications agent included in exchanging the attachment in a communication. A resource sent as an attachment is data that is typically not presented “inline” in a communicant message. Email attachments are perhaps the most widely known attachments included in communications. An email attachment is a file or other data resource sent in a portion of an email separate from a communicant message portion. As defined, other communicant messages may be sent in other types of communications along with one or more attachments.

A “communications request”, as the term is user herein, refers to request sent by a communications agent via a communications protocol. A “communications response”, as the term is user herein, refers to any response corresponding to a communications request. A communications response may be transmitted via the same communications protocol as its corresponding communications request, a different communications protocol, a web protocol, and/or via any other suitable network protocol. A “communications service”, as the term is used herein, refers to a recipient of a communications request that is included in performing the request. Performing the request may include sending a service request based on the communications request to a service application included in performing the request. A communications service and/or a service application included in performing a communications request may generate a communications response to the request.

“Service application”, as the term is used herein, refers to any application that provides access to a resource. “Resource”, as the term is user herein, refers to a data entity, a hardware component, a program component, and/or service. A service request is a request to a service application to get, create, modify, delete, move, and/or invoke a resource. A response to a service request is referred to as a service response. Data in a service response is a resource. A communications request is a type of service request.

A “web protocol”, as the term is used herein, refers to any version of a hypertext transfer protocol (HTTP) and/or any version of a HTTP secure (HTTPS) protocol. A “user agent”, as the term is used herein, refers to a client which initiates a request via a web protocol. Examples include web browsers, HTML editors, spiders (web-traversing robots), or other end user tools. A “web request”, as the term is used herein, refers to a request initiated by a user agent. A “web service”, as the term is used herein, refers to a recipient of a web request. A web service generates a response to the request. A “web response”, as the term is used herein, refers to any response that corresponds to a web request. A web response may be transmitted via the same web protocol as its corresponding web request, a different web protocol, via a communications protocol, and/or via any other suitable network protocol. A web request is a type of service request.

A “service provider”, as the term is used herein, refers to any entity that owns, maintains, and/or otherwise provides a web service, communications service, and/or other network accessible service application. The term “service provider system” is used interchangeably with services and facilities that host a web service and/or other service application of a service provider. For example, a service provider system may include a server farm, a content delivery network, a database, a firewall, etc.

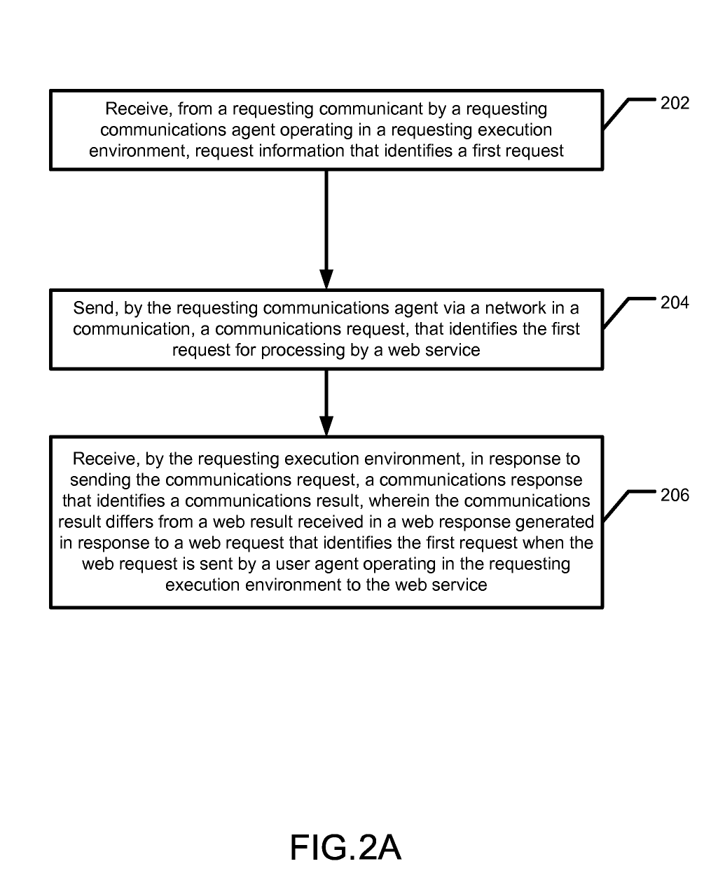

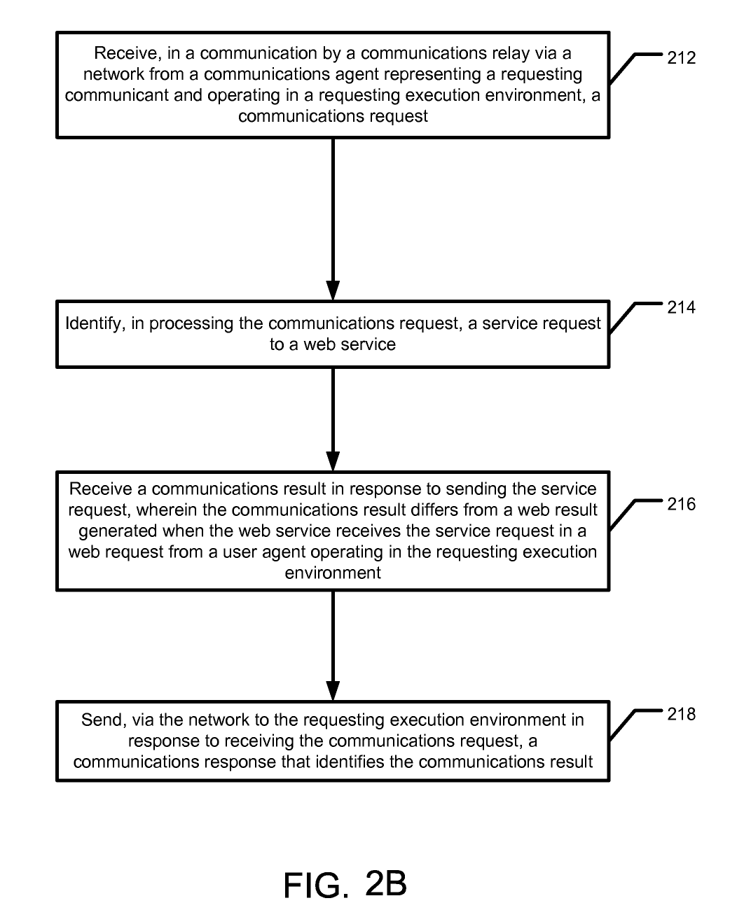

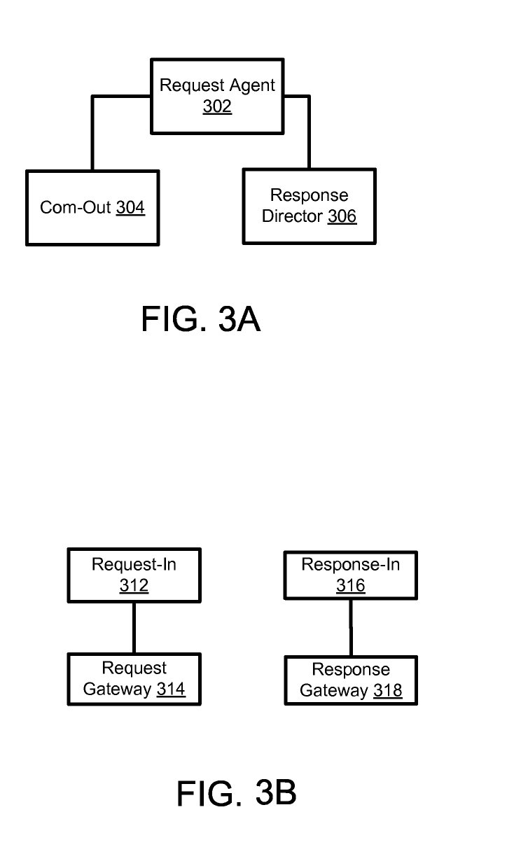

FIG. 3A illustrates an arrangement of components in a system that operates in an execution environment, such as execution environment 102 in FIG. 1. The arrangement of components in the system operates to perform the method illustrated in FIG. 2A. The system illustrated includes a request agent component 302, a com-out component 304, and a response director component 306. A suitable execution environment includes a processor, such as processor 104, to process an instruction in at least one of a request agent component, a com-out component, and a response director component. FIG. 3B illustrates an arrangement of components in a system that operates to perform the method illustrated in FIG. 2B. The system illustrated includes a request-in component 312, a request gateway component 314, a response-in component 316, and a response gateway component 318. A suitable execution environment includes a processor, such as processor 104, to process an instruction in at least one of a request-in component, a request gateway component, a response-in component, and a response gateway component.

Some components, illustrated in the drawings are identified by numbers with an alphanumeric suffix. A component may be referred to generically in the singular or the plural by dropping a suffix of a portion thereof of the component's identifier. For example, execution environments; such as requesting execution environment 401a, relay execution environment 401b, service execution environment 401c, and their adaptations and analogs; are referred to herein generically as an execution environment 401 or execution environments 401 when describing more than one. Other components identified with an alphanumeric suffix may be referred to generically or as a group in a similar manner.

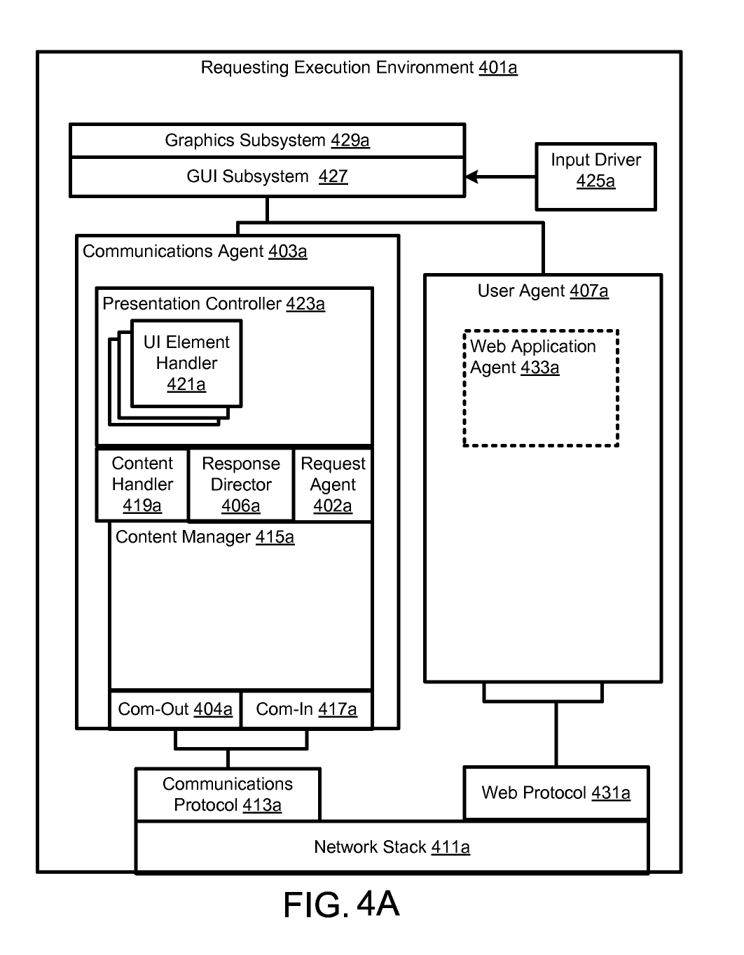

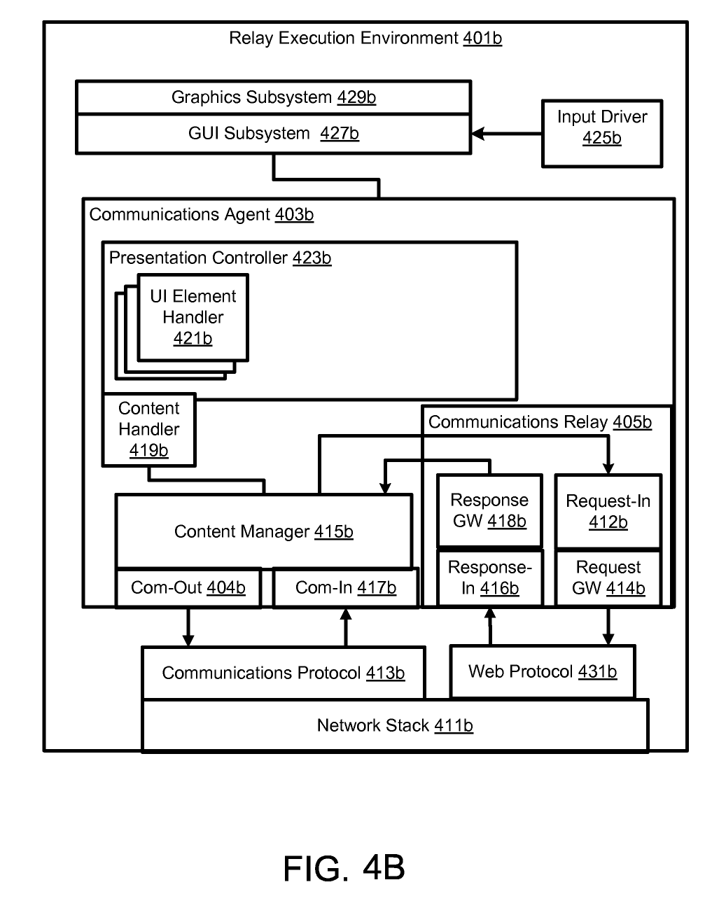

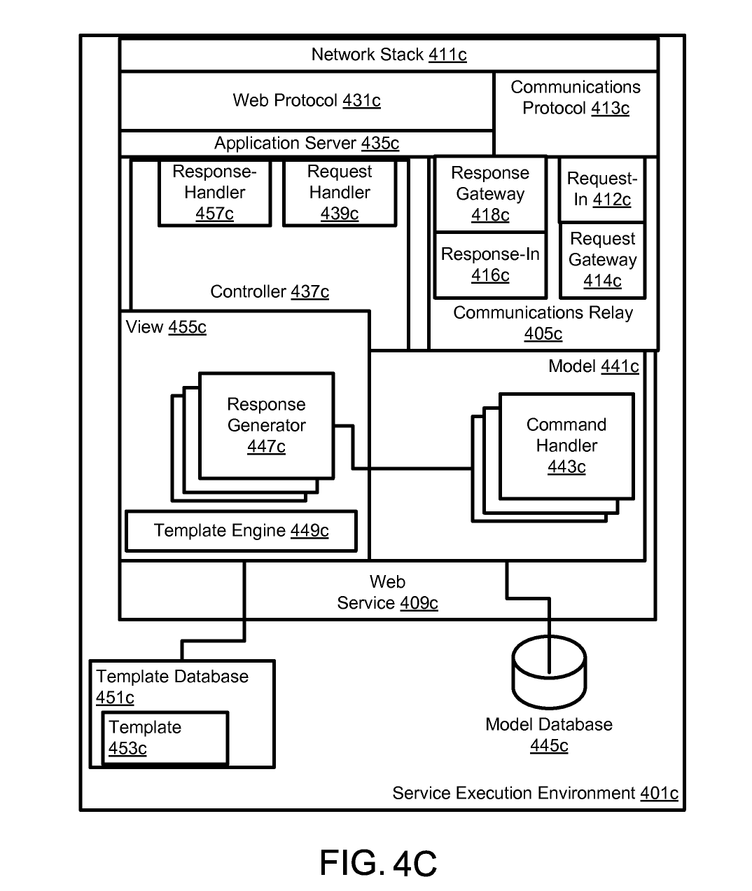

Some or all of the exemplary components illustrated in FIG. 3A and in FIG. 3B, their adaptations, and/or their analogs may operate in a number of execution environments to perform the method illustrated in FIG. 2A and/or the method illustrated in FIG. 2B. FIG. 4A is a block diagram illustrating the components of FIG. 3A and/or analogs of the components of FIG. 3A that are operable in a first execution environment referred to herein for illustrative purposes as a requesting execution environment 401a to perform the method illustrated in FIG. 2A. FIG. 4B is a block diagram illustrating the components of FIG. 3B and/or analogs of the components of FIG. 3B that are operable in a second execution environment referred to herein for illustrative purposes as a relay execution environment 401b to perform the method illustrated in FIG. 2B. FIG. 4C is a block diagram illustrating the components of FIG. 3B and/or analogs of the components of FIG. 3B that are operable in a third execution environment referred to herein for illustrative purposes as a service execution environment 401c to perform the method illustrated in FIG. 2B. In an aspect, the components of FIG. 3B and/or analogs of the components of FIG. 3B may operate in relay execution environment 401b and in service execution environment 401c in a distributed fashion. Some components illustrated in FIG. 3B may operate in relay execution environment 401b while others operate in service execution environment 401c. One or more components may operate partially in relay execution environment 401b and partially in service execution environment 401c.

Each execution environment 401 in FIGS. 4A-C is included in and/or otherwise is provided by one or more nodes. FIG. 1 illustrates key components of an exemplary device that may at least partially provide and/or otherwise may be included in an execution environment. The components illustrated in FIGS. 4A-C may be included in or may otherwise be combined with the components of FIG. 1 to create a variety of arrangements of components according to the subject matter described herein.

As stated, the various adaptations of the arrangement in FIG. 3A as well as the various adaptations of the arrangement in FIG. 3B illustrated and described herein are not exhaustive. For example, those skilled in the art will see, based on the description herein, that arrangements of components to perform the method illustrated in FIG. 2A and the method illustrated in FIG. 2B may each be distributed across more than one node and/or execution environment.

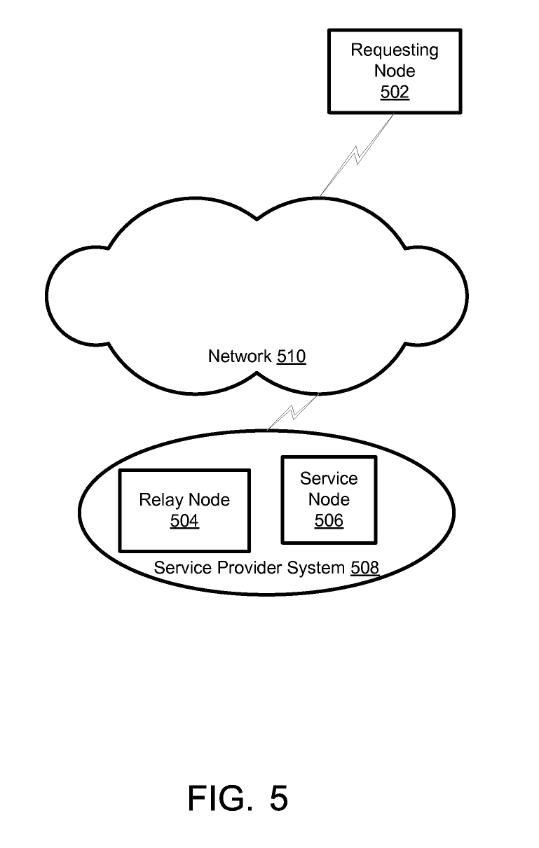

FIG. 5 illustrates a first node referred to herein for illustrative purposes as a requesting node 502, a second node referred to herein for illustrative purposes as a relay node 504, and a third node referred to herein for illustrative purposes as a service node 506 as exemplary devices that each may be included in and/or otherwise may provide an instance, adaptation, and/or analog of an execution environment 401 in any of FIGS. 4A-C. Requesting execution environment 401a may include and/or may otherwise be provided at least in part by requesting node 502. Relay execution environment 401b may include and/or may otherwise be provided, at least in part, by relay node 504. Service execution environment 401c may include and/or may otherwise be provided, at least in part, by service node 506.

FIG. 5, illustrates relay node 504 and service node 506 included in and/or otherwise provided by a service provider system 508, operated and/or otherwise provided by a business, other organization, individual, or other legal entity. Service provider system 508 may include one or more execution environments including and/or provided by one or more nodes. Service provider system 508 may include a server farm, a content delivery network, firewalls, and the like. A service provider system may be distributed throughout some or all of a network, illustrated in FIG. 5 by network 510. Those skilled in the art will understand that relay execution environment 401b of relay node 504 and service execution environment 401c of service node 506 may be provided by different service provider systems. Requesting execution environment 401a may include and/or may otherwise be provided at least in part by requesting node 502. Requesting execution environment 401a and service provider system 508 are operatively coupled to a network 510 via respective network interface components in requesting node 502 and in one or both of relay node 504 and service node 506 enabling requesting execution environment 401a to exchange data via network 510 with one or both of relay execution environment 401b of relay node 504 and service execution environment 401c of service node 506.

FIGS. 4A-C illustrate various applications in respective execution environments 401. FIG. 4A illustrates an adaptation of the arrangement of components in FIG. 3A in a communications agent 403a application. Communications agent 403a may operate in requesting execution environment 401a of requesting node 502 on behalf of a requesting communicant to communicate with a communications relay, illustrated in FIG. 4B operating in communications agent 403b as communications relay 405b and also illustrated in FIG. 4C operating in service execution environment 401c of service node 506 as communications relay 405c. FIG. 4A also illustrates a user agent 407a application, such as a web browser. User agent 407a may operate in requesting execution environment 401a of requesting node 502 to communicate with one or more web services, such as web service 409c, illustrated in FIG. 4C operating, as a web accessible application, in service execution environment 401c of service node 506. As described, FIG. 4C also illustrates an alternative and/or additional communications relay 405c that may interoperate with communications relay 405b. In another aspect, one or both of the communications relays 405 may operate without interoperating with the other. Those skilled in the art will further understand, that applications, illustrated in relay execution environment 401b by communications relay 405b, and applications, illustrated in service execution environment 401c by web service 409c, and communications relay 405c, their adaptations and/or their analogs may operate together in a single execution environment 401.

A communications relay 405 may be and/or may include one or more of a mail server, relay, gateway, and/or proxy; an instant message server, relay, gateway, and/or proxy; a voice of IP (VoIP) switch, relay, gateway, and/or proxy, a presence server, relay, gateway, and/or proxy; and a video switch, relay, gateway, and/or proxy—to name a few examples. Those skilled in the art will understand that a communications relay 405 may be included in and/or otherwise may be an adaptation of a communications agent. As such, communications relay 405b may represent one or more communicants by being included in communications agent 403b.

Applications in FIG. 4A-C, operating in respective execution environments 401 may interoperate via respective network stacks 411. Applications may exchange data via network 510, in FIG. 5, via one or more network protocols such as a communications protocol and/or a web protocol. FIGS. 4A-C each illustrate a respective communications protocol component 413 exemplifying a subsystem to exchange data via network 510 according to one or more communications protocols, such as a simple mail transfer protocol (SMTP), a post office protocol (POP), an instant messaging protocol, and/or a real-time voice and/or video protocol. A communication may include an exchange of one or more types of data and may use one or more communications protocols in exchanging the one or more types of data via network 510.

Instances, adaptations, and/or analogs of applications in FIG. 4A-C may communicate via a request/reply protocol, a data streaming protocol, a session and/or connection-oriented protocol, a connectionless protocol, a real-time communications protocol, an asynchronous communication, a store and forward communications protocol, a reliable delivery communications protocol, a best-effort delivery communications protocol, and/or a secure protocol, to name a few communications options.

FIGS. 4A-B illustrate respective communications agents 403 including respective content manager components 415. A content manager component 415 may interoperate with a communications protocol layer component 413 and/or a network stack 411 to receive data in one or more communications via network 510 in FIG. 5 with another communications agent, a communications relay, and or other compatible component in another execution environment and/or node. A content manager component 415 may be operatively coupled, via a com-in component 417, to a communications protocol component 413 to receive the data from the other execution environment and/or the other node.

Data received in a communication may include one or more content types. Exemplary content types include plain text, markup such as hypertext markup language (HTML), audio data, image data, and/or executable data. Executable data may include script instruction(s), byte code, and/or machine code. In FIG. 4A and in FIG. 4B, communications agent 403a and communications agent 403b may include one or more content handler components 419 to process data received according to its content type. A content type may be identified by a MIME type identifier and/or a file type extension, for example. Exemplary content handler components 419 include a text/html content handler component to process HTML representations; an application/xmpp-xml content handler component to process extensible messaging and presence protocol (XMPP) streams including presence tuples, instant messages, and audio content handler components including and/or that may in operation retrieve suitable codices; one or more video content handler components to process video representations of various types; and still image data content handler components to process various image data representations.

Content handler component(s) 419 process data based on a content type of the data and may transform the data into and/or generate from the data to provide and/or otherwise identify to one or more user interface element handler components 421. One or more user interface element handler components 421 are illustrated in respective presentation controller components 423 in FIGS. 4A-B. A presentation controller component 423 may manage visual, audio, and other types of output for its including application as well as receive and route detected user and other inputs to components and extensions of its including application. A user interface element handler component 421 may operate at least partially in a content handler component 419 such as a text/html content handler component and/or a script content handler component. Additionally or alternatively, a user interface element handler component in an execution environment 401 may be received in a communication. For example, a communication, such as an email, may include an HTML content type portion and a script content type portion.

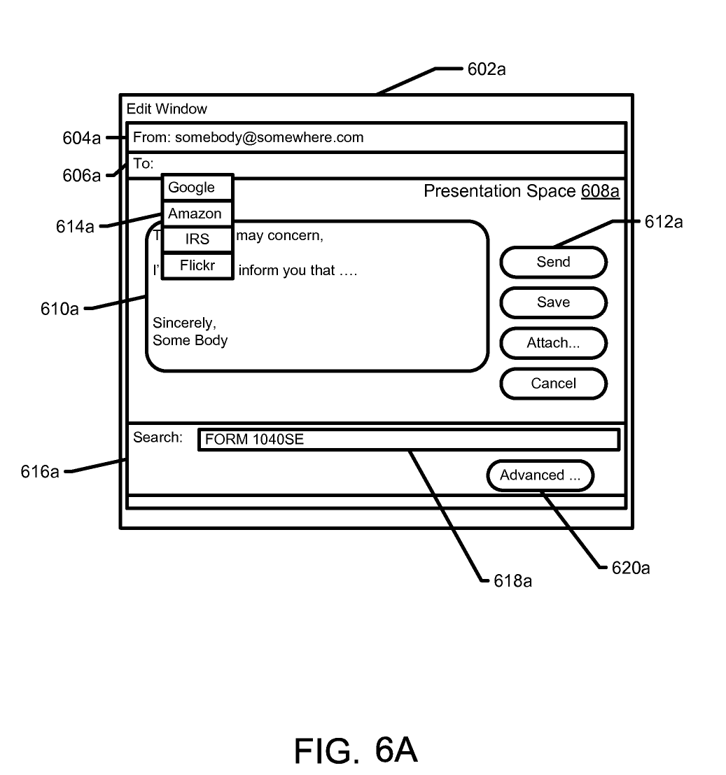

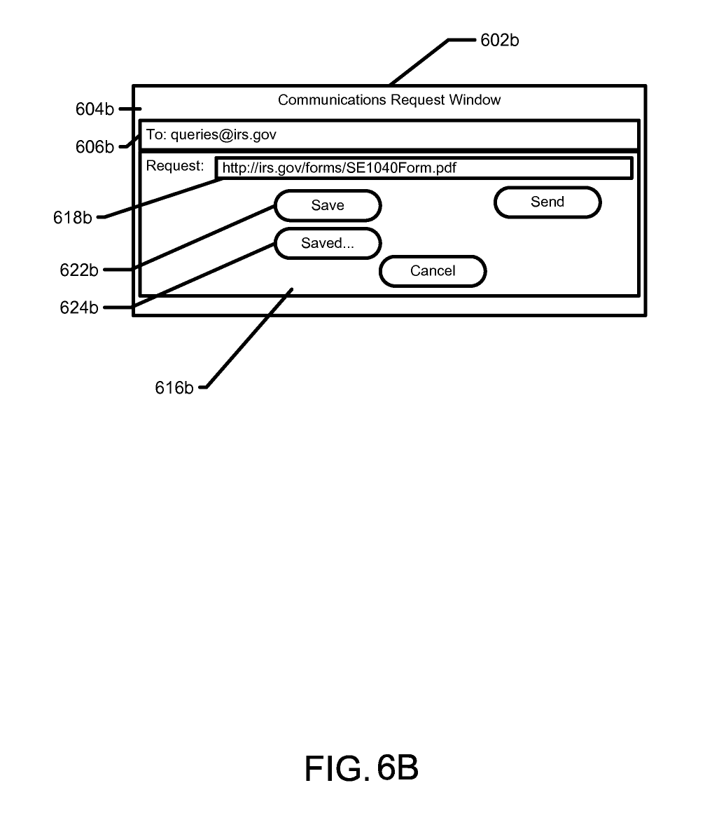

FIGS. 6A-B illustrate respective UI elements 602 presentable in a presentation space of a display device, such as output device 130 in FIG. 1, by a communications agent 403. An edit UI element window 602a, in FIG. 6A, includes a contactor user interface (UI) element 604a including an identifier of a communicant in the role of a contactor in a communication represented by the edit UI element 602a. Edit UI element 602a, in FIG. 6A, also includes a contactee UI element 606a to present one or more contactee identifier(s) identifying one or more communicants in the role of contactee(s) included in the communication. A presentation space 608a is provided in edit UI element 602a to present a communicant message UI element 610a that may include a presentation of a communicant message addressed to one or more contactees identified in the contactee UI element 606a. The presentation space 608a may also be provided to present one or more UI controls to exchange data in and/or otherwise manage the data in the communication. A send UI element 612a illustrates an exemplary UI control element that may correspond to user input to send data in a communication to one or more identified contactees.

In FIG. 4A, data to send in a communication to a communications agent 403 and/or to a communications relay 405 may be received by one or more content handler component(s) 419a operating in requesting execution environment 401a to transform the data into one or more data representations suitable to transmit in the communication and/or suitable to process by a communications relay 405, such as in relay execution environment 401b and/or in service execution environment 401c. The one or more data representations may be provided to content manager component 415a to send in the communication to the communications relay 405. Content manager component 415a may package and/or otherwise prepare for packaging the one or more data representations in a data unit or message formatted according to a communications protocol of the communications agent 403a. Communications protocol component 413a may send the data according to the specification(s) of the communications protocol. Content manager component 415a may alternatively or additionally encode and/or otherwise transform one or more of the data representations to send in a data stream such as voice stream and/or a video stream to communicate in the communication to a communications agent via a network.

Content manager component 415a operating in requesting execution environment 401a may provide the packaged, encoded, and/or transformed data to communications protocol component 413a via a com-out component 404a. Com-out component 404a, as described above, operatively couples communications agent 415a to communications protocol component 413a according to an interface provided by communications protocol component 413a to send data in a communication according to a communications protocol. Communications protocol component 413a may further package and/or otherwise transform the data to send via network stack 411a to deliver via network 510 to a communications relay 405 operating in another execution environment.

A communicant in a communication may be identified by a communicant identifier in an address space of a communications protocol. In one aspect, information identifying a communicant identifier may be received from a communicant of a communications agent in an execution environment. In FIG. 4A, presentation controller component 423a and/or a UI element handler component 421a, presenting and/or managing interaction with contactor UI element 604 in FIG. 6A presented by requesting execution environment 401a, may receive a contactor alias in response to a user input corresponding to contactor UI element 604. The user of requesting execution environment 401a may enter a contactor alias, such a user's name, via a keyboard and/or may select a predefined communicant alias presented in a selection UI control element via a UI element handler component 421a. The user input may be detected by input driver component 425a. Corresponding input information may be routed to presentation controller component 423a by GUI subsystem 427a. GUI subsystem 427a may send presentation information to a display device via a graphics subsystem 429a. Communications agent 403a may identify a communicant identifier associated with the contactor alias, such as “somebody@somewhere.com”. Other communicant identifiers, such as for one or more contactees, may be received similarly and/or in any suitable manner.

Data may be sent in a communication according to a form or type of the communication and/or other attribute of the communication such as a security attribute, the amount of data to be sent, a priority setting, a task setting, and the like. Some forms of communication do not require a session and/or connection between communications agents and/or request-in components in a communication in order to exchange data in the communication, while others do. An email and/or instant message may use a store and forward model of delivery.

Data may be sent in a communication in response to a communicant input. A contactor may provide an input corresponding to send UI element 612a in FIG. 6A. The input may be received by presentation controller component 423a, in FIG. 4A, and/or by one or more UI element handler components 421a corresponding to send UI element 612a. In response to detecting the input, presentation controller component 423a may provide data to be sent in the communication to one or more content handler components 419a according to the content type(s) of the data to be sent.

The one or more content handler components 419a may encode, format, and/or otherwise transform the data to send in a message, such as an email message. The one or more content handler components 419a may provide data to be sent to content manager component 415a, instructing content manager component 415a to send the data in the communication to deliver to another communications agent and/or to a communications relay 405. Content manager component 415a interoperating with com-out component 404a may further format and/or transform the data to send in the communication according to a communications protocol, for example according to an email communications protocol, by communications protocol component 413a. Communications protocol component 413a may send the data in the communication to deliver to a communications relay 405 via network 510.

For session-oriented and/or connection-oriented communication a session and/or connection may be established if a session/connection has not already been established. Data may be sent to deliver to a communications agent and/or a communications relay 405 identified based on a contactee communicant identifier during session and/or connection setup. For example, for a voice communication a voice communication may be established via a session initiation protocol. Communications protocol component 413a may operate according to the session initiation protocol specifications. Communications protocol component 413a operating in requesting execution environment 401a may locate a communications agent and/or a communications relay by communicating with one or more nodes in network 510 according to the session initiation protocol. Communications protocol component 413a may locate, for example, communications relay 405b in relay execution environment 401b, based on a communicant identifier for a contactee in the communication.

Once a communication session is established, such as a voice session, data may be sent according to the session communications protocol, such as RTP. Data may be sent according to a session initiation protocol in the communication to manage the voice communication session and/or to exchange text, image, and/or other data outside of the voice session.

As described above communications agent 403b may send data in a communication to a communications agent, such as communications agent 403a, in FIG. 4A, in manner similar to that described above with respect to communications agent 403a.

FIG. 4A includes a second application illustrated by user agent 407a. As defined above, user agent 407a may be a web browser. User agent 407a in FIG. 4A and web service 409c in FIG. 4C may interoperate via respective network stacks 411 in requesting execution environment 401a and service execution environment 401c. User agent 407a and web service 409c may communicate via one or more web protocols. FIG. 4A and FIG. 4C respectively illustrate web protocol components 431. Web protocol components 431 in requesting execution environment 401a and in service execution environment 401c may exchange data via one or more versions of the Hypertext Transfer Protocol (HTTP).

User agent 407a, in FIG. 4A, may receive some or all of web application agent 433a in one more messages sent from web service 409c, in FIG. 4C, via network stacks, network interface components, and web protocol components in the respective execution environments. In FIG. 4A, user agent 403a may interoperate with web protocol component 431a and/or network stack 411a to receive the message or messages including some or all of web application agent 433a.

Web application agent 433a may include a web page or other data representation for presenting a user interface for web service 409c. The web page may include and/or reference data represented in one or more formats including hypertext markup language (HTML) and/or other markup languages, ECMAScript or other scripting languages, byte code, image data, audio data, and/or machine code to name just a few valid data representations depending on the capabilities of a receiving user agent.

In response to an HTTP request including a request received from user agent 407a, by an application server 435c. A controller component 437c, in FIG. 4C, may receive the request from application server 435c. A request handler component 439c in controller component 437c may invoke model subsystem 441c to perform request specific processing. Model subsystem 441c may include any number of command processors, illustrated as command handler components 443c, that may dynamically generate data and/or retrieve data from model database 445c based on the command. Controller component 437c may further invoke one or more response generator components 447c to generate a command response to the received command. The one or more response generator components 447c may invoke template engine component 449c to identify one or more templates and/or other static data to combine with data received from command handler component(s) 443c generated in processing the command. FIG. 4C illustrates template database 451c including one or more user interface templates 453c. The one or more response generator component(s) 447c in view subsystem 455c may interoperate with response-handler component(s) 457c in controller component 437c to return a command response generated from processing a command. The command response may be returned in one or more data formats suitable for a user agent. A response-handler component 457c may receive command response data from one or more response generator components 447c as one or more HTTP entities, and/or one or more HTTP representations. Alternatively or additionally, response handler component 457c may transform data from one or more response generator component(s) 447c into one or more HTTP entities and/or HTTP representations. Response-handler component 457c may send the one or more HTTP entities in an HTTP response, in response to the HTTP request received from user agent 407a. Some or all of a web application agent 433a may be sent to a user agent 407a via network application server 435c in the manner described.

One or more HTTP responses including one or more representations of some or all of web application agent 433a may be received by user agent 407a via web protocol component 431a and network stack 411a. In FIG. 4, user agent 407a may include one or more content handler components to process received HTTP representations according to their data types, typically identified by MIME-type identifiers. Exemplary content handler components that operate in and/or with user agent 407a include a text/html content handler component for processing HTML representations; an application/xmpp-xml content handler component for processing XMPP streams including presence tuples, instant messages, and publish-subscribe data as defined by various XMPP specifications; one or more video content handler components for processing video representations of various types; and still image data content handler components for processing various image data representations. Content handler component(s) in user agent 407a process received HTTP representations and may provide data from the HTTP representations to one or more user interface element handler components included in and/or otherwise interoperating with user agent 407a.

User agent 407a may manage visual, audio, and other types of output. User agent 407a may send presentation information to present one or more UI elements via an output device, such as a display device. The display device may include a presentation space to represent a UI element, such as a browser window or tab. The UI element may be presented by and/or on behalf of user agent 407a, web application agent 433a, and/or web service 409c.

FIGS. 4B-C illustrates respective web protocol components 431 interoperating with communications relays 405. A communications relay 405 may operate in and/or otherwise with a user agent in communicating with a web service 409c.

FIG. 4C illustrates web service 409c operatively coupled to web protocol component 431c to exchange data with one or more user agents, such as user agent 407a in FIG. 4A and/or communications relay 405b in FIG. 4B. In an aspect, web service 409c may be operatively coupled to a communications protocol component 413c as FIG. 4C illustrates. Web service 409c may exchange data in a communication with a communications agent, such as communications agent 403a, in FIG. 4A, and/or a communications relay 405b, in FIG. 4B.

With reference to FIG. 2A, a block 202 illustrates that the method includes receiving, from a requesting communicant by a requesting communications agent operating in a requesting execution environment, request information that identifies a first request. Accordingly, a system for processing a request via a communications agent includes means for receiving, from a requesting communicant by a requesting communications agent operating in a requesting execution environment, request information that identifies a first request. For example, the arrangement in FIG. 3A, includes request agent component 302 that is operable for and/or otherwise included in receiving, from a requesting communicant by a requesting communications agent operating in a requesting execution environment, request information that identifies a first request. FIG. 4A illustrate request agent component 402a as an adaptation and/or analog of the request agent component 302 in FIG. 3A. One or more request agent components 402 operate in an execution environment 401. A system for processing a request via a communications agent includes one or more processors and logic encoded in one or more computer readable media to execute by the one or more processors that when executed is operable for and/or otherwise included in receiving, from a requesting communicant by a requesting communications agent operating in a requesting execution environment, request information that identifies a first request.

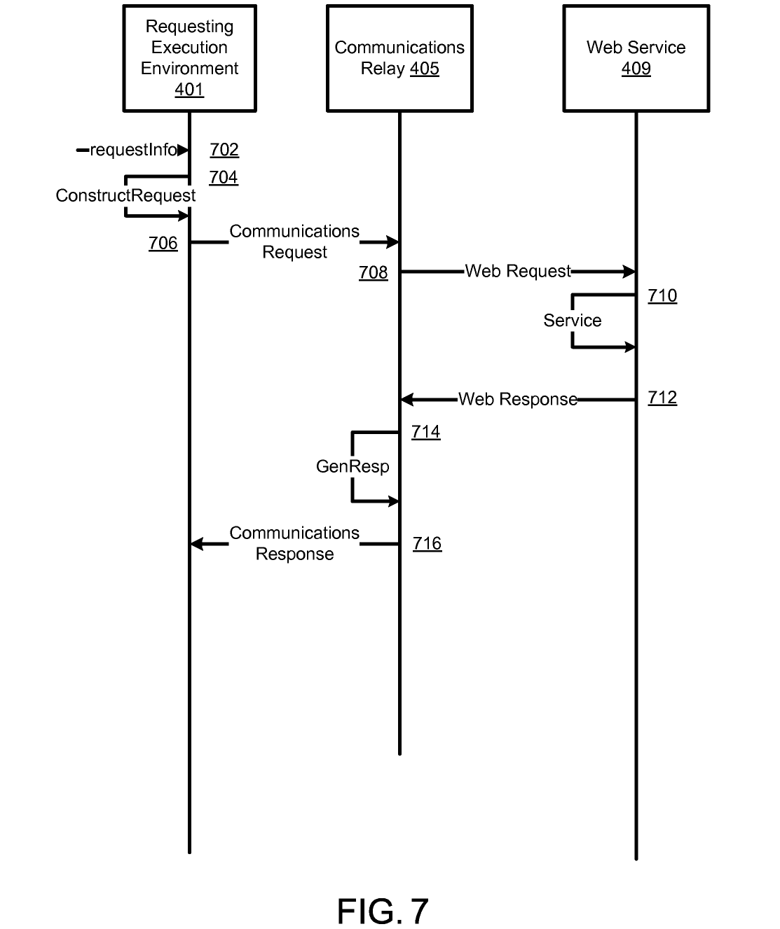

FIG. 7 illustrates a request information (requestInfo) dataflow 702 that may be a dataflow internal to requesting execution environment 401a in FIG. 4A and/or may include receiving data via network 510 by requesting execution environment 401a. Request information dataflow 702, in FIG. 7, may include receiving and/or otherwise identifying user input information to a UI element handler component 421a in communications agent 403a, in response to a user input. In an aspect, the request information may identify a URI, such as a URL. A request agent component 402a may receive the request information based on the input information. In another aspect, request information dataflow 702 may include identifying request information received by content manager component 415a, in FIG. 4A, via network 510 from, for example, a user agent operating in a node (not shown) in network 510. A request agent component 402a may receive the identified request information via interoperation with a content manager component 415a.

Receiving request information may include presenting a request input UI element to a user, via an output device. The request information may be received from the user via one or more inputs, detected by one or more input devices, where the input(s) correspond to the request input UI element. A request input UI element may be presented by a requesting communications agent in a user interface element presented to create a new communicant message; a user interface element presented to reply to a previously received communicant message; a user interface element presented to receive the request information where the requesting user is not allowed create, reply to, and/or otherwise edit a communicant message; and/or a main application window of the requesting communications agent.

FIG. 6A illustrates an exemplary user interface that may be presented to create a new communicant message via interaction with a user. The user interface in FIG. 6A may be presented by communications agent 403a, in FIG. 4A, operating in requesting execution environment 401a of requesting node 502 in FIG. 5. A UI element handler component 421a may operate to present a user interface element to allow a user to identify request information, for example, to perform a search. A request UI element 616a is illustrated in FIG. 6A as an example. The same or different UI element handler component 421a may present various other UI elements included in request UI element 616a. Request UI element 616a and one or more UI elements it includes may be presented by one or more corresponding UI element handler component(s) 421a that may operate based on a schema that defines valid request information to create a communications request by communications agent 403a. The schema defines one or more rules and/or a vocabulary that defines whether request information is valid.

Those skilled in the art will understand that numerous languages and/or schemas for providing request information for various types of requests currently exist and more will be specified. For example, request information may include and/or otherwise identify search information to create a search query for a search engine. Request information may identify a resource such a file and/or a service to access. Request information may include data to store and/or otherwise process by a web service.

A request input UI element, as described above, may be included in a plurality of request input UI elements presentable by the requesting communications agent. Presenting a request input UI element may include selecting and/or otherwise identifying, based on a service provider system 508, the request input UI element from the plurality of request input UI elements. The selected request UI element may be presented in response to and/or otherwise based on the selection. Alternatively or additionally a request UI element may be selected and/or otherwise determined from a plurality of request UI elements, based on a communicant identifier included in a communication. The communicant identifier identifies a communicant in the communication. The communicant may be a contactee and/or a contactor. As such, the request UI element may be selected based on the requesting communicant. Further, with respect to the requesting communicant, a request UI element may be selected by a requesting communicant. Selection information may be received from the requesting communicant via an input device. The selection information identifies the request input UI element to present.

Request UI element 616a illustrates a user interface presented, based on a keyword based schema, to receive request information as search information. Search UI element 618a illustrates a textbox allowing a user to enter a keyword expression. An advanced button UI element 620a allows communications agent 403a to receive additional request information typical of advanced searches supported by current search engines. A user input detected that corresponds to advanced button UI element 620a may result in communications agent 403a presenting a dialog box including one or more form UI elements to receive input from the user specifying advanced search options. Communications agent 403a may support more than one request information schema. Thus, a communications agent may provide a user interface to receive valid request information for a number of respective schemas. Context menu UI element 614a, in FIG. 6A, illustrates service providers of system provider systems including a search engine, a government website, an online retailer, and a photo-sharing web site. An input from a user corresponding to a web service and/or a service provider, such as Amazon 614a, may be mapped and/or otherwise associated with a communicant identifier for a service provider system. A communications request based on the request information may be sent based on the communicant identifier.

FIG. 6A illustrates a request input UI element integrated with a user interface presented to interact with a user to generate and/or otherwise edit a communicant message. Alternatively or additionally, a communications agent may provide a request input UI element integrated in to a main window presented by the communications agent and/or may present a request input UI element in a tab and/or in a dialog box.

FIG. 6B illustrates an arrangement of UI elements some or all of which may be presented as a dialog box, in a tab, and/or in main window of communications agent 403a in FIG. 4A. As with FIG. 6A, a UI element handler component 421a may operate to present a request UI element 616b, illustrated in FIG. 6B, in communications request window UI element 602b. The same or different UI element handler component 421a may present various other UI elements included in request UI element 616b. Request UI element 616b and one or more UI elements it includes may be presented by one or more corresponding UI element handler component(s) 421a that may operate based on a schema that defines valid request information to create a communications request by communications agent 403a. Request UI element 618b allows a communications agent interacting with a user to receive input identifying a URI such as an HTTP URL. A communicant identifier for a contactee may be entered by the user or determined automatically based on the URI and/or otherwise based on an identified request. A contactee communicant identifier may be based on a type of request identified by request information. Exemplary types of requests include a search request, a service access request, a data access request, a data submit request, a create request, a delete request, and a change request—too name a few examples. A request may have one or more types.

A mapping template may be used to map a URL to a communicant identifier. For example, an HTTP URL may be mapped to an email address and/or URL or other type of communicant identifier. In an aspect, a communicant identifier may be designated for receiving communications requests, such as request.gateway@irs.gov to receive and relay all communications requests. FIG. 6B illustrates queries@irs.gov communicant identifier as a communicant identifier that may be defined to receive all communications requests for the IRS for certain specified types or categories of communications requests. In an aspect, a search@irs.gov communicant identifier may be defined to address communications requests identifying a search query. A submit@irs.gov communicant identifier may be defined for submitting documents or other data to the IRS. A pay@irs.gov communicant identifier may be defined for paying fees or for purchases. A communicant identifier naming pattern may be standardized across multiple service provider systems.

As described, request UI element 618b illustrates a textbox allowing a user to enter a URI. A save button UI element 622b may be provided to receive input information from a user instructing requesting agent 402a to save request information received via request UI element 616b. A favorites list may be created via this means. A saved button UI element 624b may be provided to receive input information from a user instructing requesting agent 402a to retrieve saved request information. Selection information may be received by requesting agent 402a that identifies an instance of request information to fill in data in request UI element 616b for the user. In another aspect, a history of communications requests may be maintained by communications agent. The history may be presented to a user allowing the user to save requests as favorites and/or otherwise reuse previously sent communications requests.

FIG. 7 illustrates a construct request dataflow 704 that may be a dataflow internal to requesting execution environment 401a in FIG. 4A and/or may include receiving data via network 510 by requesting execution environment 401a. Construct request dataflow 704, in FIG. 7, may include an exchange of request information and/or information based on request information received by and/or otherwise identified to a UI element handler component 421a interoperating with request agent component 402a, in FIG. 4A. A construct request dataflow may be and/or may occur in response to a user input, detected by communications agent 403a. The user input may be specified to identify a command to send a communications request based on received request information in a request information dataflow. In another aspect, a construct request dataflow may include an exchange of request information and/or information based on request information received by content manager component 415a and provided to request agent component 402a, via network 510 from, for example, a browser operating as a user agent in a node (not shown) in network 510

A request agent component may be a type of content handler component that operates to process request information to create a communications request that conforms to a schema to create and/or otherwise to construct a valid communications request. A request agent component may construct from and/or otherwise transform request information into a communications request based on a schema that defines and/or otherwise identifies a valid communications request for a particular type of data unit, message, and/or communication supported by a communications agent. Request agent component 402a, operating in requesting execution environment 401a of requesting node 502, may provide the communications request to content manager component 415a to include and/or otherwise identify the communications request in a message and/or data unit of a communications protocol in a communication with a communications relay 405. The communications relay 405 may forward a request based on the communications request to a web service identified based on the communication.

As described above, content manager component 415a, in FIG. 4A, may operate in requesting execution environment 401a to transform request information into a communications request to include along with data for other parts of a communication into one or more data representations suitable for transmitting in the communication, such as a communicant message, to another node, such as relay execution environment 401b of relay node 504 or service execution environment 401c of service node 506. Some or all of the data representations transmitted are suitable for processing by a receiving communications relay 405. Content manager component 415a in the requesting execution environment 401a may package the one or more data representations including a representation of the communications request into a message and/or data unit according to the communications protocol.

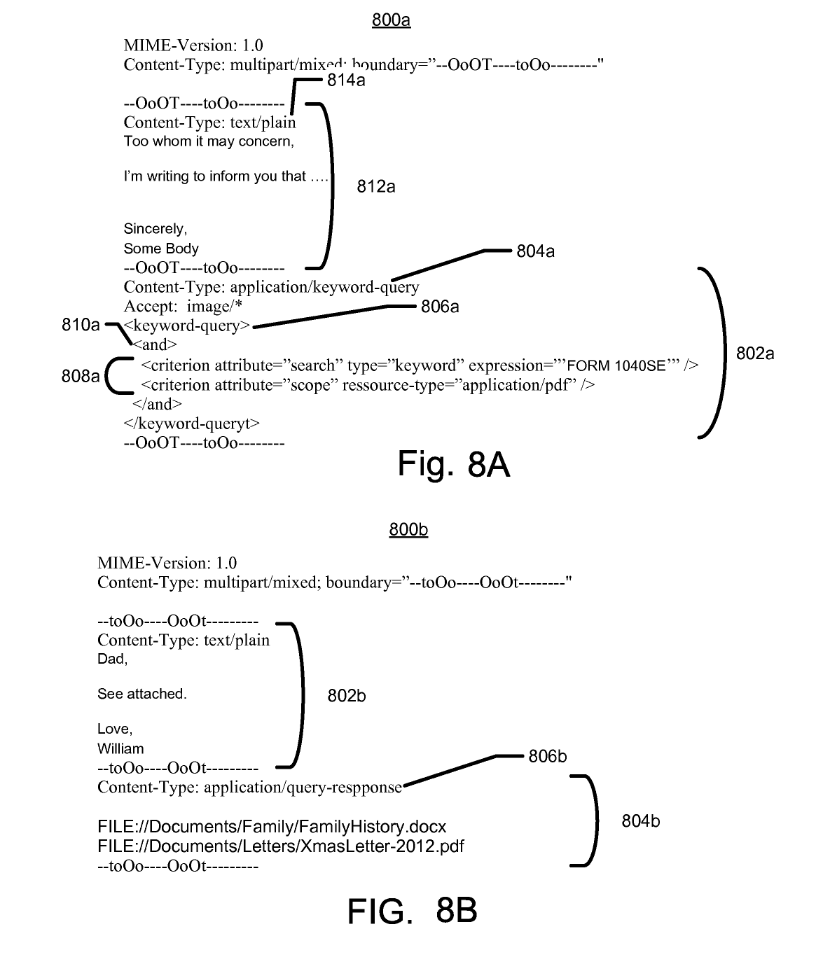

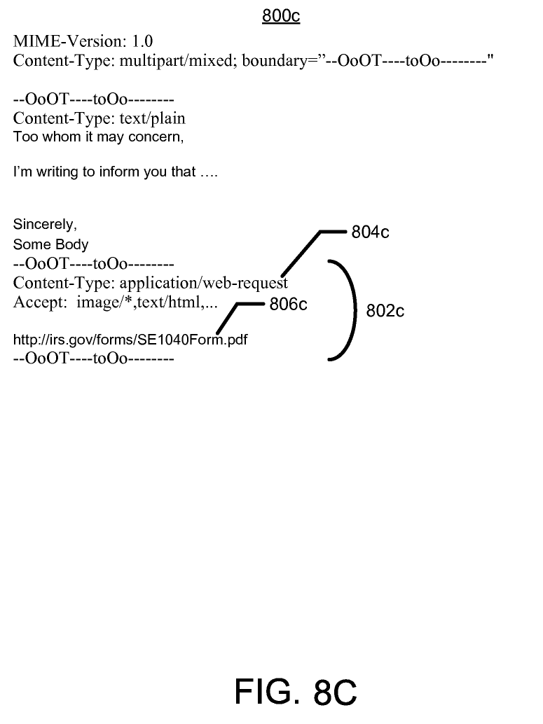

In FIG. 8A, a portion of an email communication 800a is illustrated formatted as a multipart/mixed content type including communications request portion 802a. A communications request portion of a communication may be identified as a communications request by its location in the communication and/or by an identifier or markup element, such as a MIME type identifier. A communications request may be detected based on content included in the message and/or based on metadata such as content-type header 804 identifying a MIME type identifier, such as “application/keyword-query”, which may be defined to represent one or more matching criteria in a communications request that identifies a search request. The “application/keyword-query” MIME type identifier is exemplary. Other MIME type identifiers exist and/or may be defined to identify a communications request in a communication.

A request agent component 402a and/or a content manager component 415a, in FIG. 4A, may operate to construct a communications request in a message and/or a data unit of a communications protocol based on an XQuery expression, a regular expression language, and/or SQL content—to name a few examples. A content type identifier may be included in a position and/or location that identifies a communications request in a communication. The position or location may be absolute or relative. For example, a schema for a communication may define that a communications request in a communication is included in the communication at the end of the communication. There may be one or more search queries at the end. In another aspect, a schema for a communication may specify that a portion of a communication following a particular message portion is a communications request. Other search queries and/or other types of requests may follow. If no communications request is included, the communications request portion may include no content, may include an indicator that no communications request is included, or may be absent.

FIG. 8A illustrates an “application/keyword-query” MIME type identifier that may be defined to identify a schema for an XML-based language for specifying keyword-query XML documents. FIG. 8A illustrates keyword-query document 806a. Keyword-query document 806a, as illustrated, includes criterion tag elements 808a corresponding to the form elements in FIG. 6A and/or form elements in an advanced search user interface element. A criterion tag element 808a identifies a resource matching criterion name, such as “search” indicating that the criterion is a search expression or a portion thereof. A “type” attribute identifies a schema with the identifier “keyword” for the expression. The criterion tag element 808a identifies a value for a query expression “FORM 1040SE” in an expression attribute. Another criterion tag element 808a specifies a scope for resource types identifying that only PDF documents should be identified in a response to the search request. FIG. 8A illustrates an “and” tag 810a indicating that all the matching criteria must be met to identify a resource. An “or” tag (not shown) may be defined by a schema for keyword-query documents. Other operator elements and operator precedence may be defined by the schema. Grouping elements to manage operator precedence, such as a parenthesis element, may be defined by the schema.

In FIG. 8C, a portion of a communication 800c is illustrated also formatted as a multipart/mixed content type including communications request portion 802c. The communications request may be detected based on a content-type header 804c identifying a MIME type identifier, such as “application/web-request”, which may be defined to identify an HTTP URL 806c identifying a request.

With reference to FIG. 2A, a block 204 illustrates that the method includes sending, by the requesting communications agent via a network in a communication, a communications request, that identifies the first request for processing by a web service. Accordingly, a system for processing a request via a communications agent includes means for sending, by the requesting communications agent via a network in a communication, a communications request, that identifies the first request for processing by a web service. For example, the arrangement in FIG. 3A, includes com-out component 304 that is operable for and/or otherwise included in sending, by the requesting communications agent via a network in a communication, a communications request, that identifies the first request for processing by a web service. FIG. 4A illustrate com-out components 404a as an adaptation and/or analog of the com-out component 304 in FIG. 3A. One or more com-out components 404 operate in an execution environment 401. A system for processing a request via a communications agent includes one or more processors and logic encoded in one or more computer readable media to execute by the one or more processors that when executed is operable for and/or otherwise included in sending, by the requesting communications agent via a network in a communication, a communications request, that identifies the first request for processing by a web service.

FIG. 7 illustrates a communications request dataflow 706 that may include transmitting a data unit and/or message of a communications protocol. The data unit and/or message may be sent via the communications protocol from communications agent 403a operating in requesting execution environment 401a in FIG. 4A via network 510 and received by a communications relay 405. The communications relay 405 may forward the communications request and/or a web request based on the communications request to a web service 409 of a service provider system. In another aspect, a communications request dataflow may represent an exchange via a web protocol.

Some or all of a communications relay may operate in an execution environment of a service provider system with some or all of the web service. Alternatively or additionally, a web service or a portion thereof may operate in an execution environment of a service provider system while the some or all of a communicatively coupled communications relay may operate in another execution environment. The other execution environment may be an execution environment of the service provider system or may be an execution environment provided by another service provider system.

FIG. 4B, illustrates communications relay 405b operating in relay execution environment 401b of relay node 504 in FIG. 5. Com-out component 404a in requesting execution environment 401a may send a communications request to communications relay 405b operating in a relay execution environment 401b. Communications relay 405b may receive the communications request to forward and/or otherwise relay the communications request or a web request based on the communications request to web service 409c operating in service execution environment 401c of service node 506.

FIG. 4C, illustrates communications relay 405c operating in service execution environment 401c of service node 506. Com-out component 404a in requesting execution environment 401a may send a communications request to communications relay 405c. Communications relay 405c may receive a communications request to forward and/or otherwise relay the communications request or a web request based on the communications request to web service 409c operating in service execution environment 401c of service node 506. Which web service a communications request and/or a web request is sent to and/or forwarded to may be based on a communicant identifier of a communicant identified in the communication that includes the communications request. For example, a communications request may be included in an email and/or an instant message addressed to a communicant represented by a communications agent including and/or otherwise interoperating with a communications relay 405. Those skilled in the art will understand that the communications request may be sent to one or more web services based on one or more communicant identifiers respectively identifying one or more contactees. Com-out component 404a may interoperate with other types of content handler components 419a via content manager component 415a to create and/or otherwise construct a message and/or data unit of a communications protocol that includes the valid communications request.

A communications request generated by request agent component 402a, in FIG. 4A, along with a communicant message and any other data to include in a communications request dataflow 706, may be provided and/or otherwise identified to content manager component 415a to send via com-out component 404a. Content manager component 415a in requesting execution environment 401a of requesting node 502 may package the one or more representations including a representation of the communications request into a communication formatted according to the communications protocol. Com-out component 404a may provide the communications request, the communicant message, and any other data to send in a communication in representations suitable to send by communications protocol component 413a to a communications agent and/or a communications relay 405, such as communications relay 405b in relay execution environment 401b of relay node 504. In another aspect, a communications agent and/or communications relay receiving a communications request and/or a request otherwise identifying a communications request may operate in an execution environment with a web service as illustrated by communications relay 405c in service execution environment 401c of service node 506.

Content manager component 415a and/or com-out component 404, in FIG. 4A, may alternatively or additionally encode and/or otherwise transform one or more of the data representations to send in a data stream such as voice stream and/or a video stream to communicate in a communication with components of communications relay 405 in relay execution environment 401b and/or in service execution environment 401c.

In an aspect, a communications request may be sent in a communication along with a communicant message addressed with a contactee communicant identifier. In an aspect, a communications request may be included in a communicant message. For example, a URI or a portion thereof may be included in a communicant message as a communications request. The contactee communicant identifier may be in an address space of a communications protocol via which data is exchanged in the communication. The contactee communicant identifier may identify a communicant represented by a receiving communications agent and/or a communications relay. Further, a communicant identifier, in an address space of a communications protocol that identifies a communicant in a communication, may be included in the communication to allow an authentication and/or an authorization operation to be performed for the request.

With reference to FIG. 2B, a block 212 illustrates that the method includes receiving, in a communication by a communications relay via a network from a communications agent representing a requesting communicant and operating in a requesting execution environment, a communications request. Accordingly, a system for processing a request via a communications agent includes means for receiving, in a communication by a communications relay via a network from a communications agent representing a requesting communicant and operating in a requesting execution environment, a communications request. For example, the arrangement in FIG. 3B, includes request-in component 312 that is operable for and/or otherwise included in receiving, in a communication by a communications relay via a network from a communications agent representing a requesting communicant and operating in a requesting execution environment, a communications request. FIG. 4B-C illustrate request-in components 412 as adaptations and/or analogs of request-in component 312 in FIG. 3B. One or more request-in components 412 operate in an execution environment 401. A system for processing a request via a communications agent includes one or more processors and logic encoded in one or more computer readable media to execute by the one or more processors that when executed is operable for and/or otherwise included in receiving, in a communication by a communications relay via a network from a communications agent representing a requesting communicant and operating in a requesting execution environment, a communications request. In FIG. 4B, request-in component 412b is illustrated as a component of communications relay 405b. In FIG. 4C, request-in component 412c is illustrated as a component of web service 409c. In an aspect, request-in component 412b and request-in component 412c may operate as a distributed request-in component.

FIG. 7, as described above, illustrates communications request dataflow 706, including and/or otherwise identifying a communications request received via network 510 by a request-in component 412 in a communications relay 405. A communications request dataflow may include a communications request received by request-in component 412b in communications relay 405b in relay execution environment 401b of relay node 504. In another aspect, a communications request may be received by a request-in component 412c operating in a communications relay 405c in service execution environment 401c along with a web service 409c, illustrated in FIG. 4C. A communications request dataflow may include data sent from requesting execution environment 401a. A receiving request-in component 412 may operate in one or both of relay execution environment 401b and service execution environment 401c to receive and/or otherwise process the data.

A communications request may be received by request-in component 412b, in FIG. 4B, via a network interface of relay node 504 in FIG. 5. In another aspect, a communications request may be received by communications protocol component 413c, in FIG. 4C, via a network interface of service node 506.

A request-in component 412 may be included in or may otherwise interoperate with a communications agent representing a communicant identified as a contactee in a communication in which a communications request is received. The communications agent may represent one or more communicants. A communications request may be received by service execution environment. Some or all of web service may operate in the service execution environment to process the communications request. A communications request may be received by a communications relay. The communications relay may forward the communications request and/or a web request based on the communications request to a web service. Additionally, forwarding may include creating a communications request and/or web request by a translation and/or transformation to prepare a request or a representation thereof suitable for processing by a web service.

In FIG. 4B, request-in component 412b may send a communications request and/or a web request, based on a received communications request, to a web service via a request gateway component 414. A request gateway component 414 may prepare a communications request for a web service 409c. Operation of a request gateway component 414 is described in more detail below. A request gateway component may operate in a same execution environment as a request-in component and/or may be distributed across multiple execution environments. FIG. 4B illustrates request gateway component 414b in communications relay 405b. FIG. 4C illustrates a request gateway component 414c in a separate execution environment than request-in component 412b. In FIG. 4C request-in component 412c may forward a communications request and/or a web request based on a received communications request to a web service via a request gateway component 414c.

As described, some or all of a communications relay and some or all of a web service may operate in an execution environment in a same service provider system. In another aspect, some or all of a web service may operate in an execution environment in a service provider system while a communications relay or a portion thereof operates in an execution environment provided by another service provider system.

In FIG. 4B, a content manager component 415b may operate to detect a communications request received and/or otherwise identified in one or more messages and/or data units, of a communications protocol, received in a communication. Content manager component 415b operating in relay execution environment 401b may receive the message in a communication with requesting execution environment 401a. Com-in component 417b in relay execution environment 401b may receive the message via communications protocol component 413b and network stack 411b. The message and/or communications request may be delivered to execution environment 401b of relay node 504 via network 510 based on a communicant identifier of a communicant represented by communications relay 405b in relay execution environment 401b of relay node 504.

A communications request dataflow may include receiving a communications request in one or more packets via network 510 by network stack 411b and data units of communications protocol component 413b in an instance of and/or analog of execution environment 401b, in FIG. 4B. Data in a communications request dataflow may be received by com-in component 417b. Com-in component 417b may provide the data to content manager component 415b. Content manager component 415b may determine that the data is to be relayed. For example, one or more content types of the data may indicate the data is to be relayed. The content and/or portions of the content may be provided to request-in component 412b based on the one or more content types identified by content manager component 415b.

In an aspect, content manager component 415b, in FIG. 4B, may detect content type information to detect a communications request in a communication. For example, the communicant message portion illustrated in FIG. 8C may be received in a communications request dataflow. Content manager component 415b may detect “application/web-request” MIME type identifier in content-type header 804c. The “application/web-request” MIME type identifier may be defined to identify a communications request. Content manager component 415b may identify communications request portion 802c as including a communications request.

In response to detecting a communications request, content manager component 415b may provide some or all of the communications request to request-in component 412b. For example, request-in component 412b may be configured to operate according to a schema defining a format and/or a vocabulary for an XML-based language for keyword-query documents as illustrated in FIG. 8A. Content manager component 415b may provide keyword-query document 806a, as a communications request, to request-in component 412b. Request-in component 412b may operate according to the keyword-query schema. In an aspect, a communications relay 405 may process more than one communications request content type. Alternatively or additionally, relay execution environment 401b may include multiple request-in components 412b to support multiple communications request content types.

As described above, a communications request may be received in a communication along with a communicant message addressed with a contactee communicant identifier, in an address space of a communications protocol via which data is exchanged in the communication. The contactee communicant identifier may identify a communicant represented by a receiving communications agent and/or a receiving communications relay.

A communicant identifier identifying a communicant in the communication and received in the communications may be received to perform an authentication operation and/or an authorization operation for a received request. In an aspect, a communicant message may be delivered to a communicant of communications relay 405b, operating in and/or with a communications agent 403b representing the communicant. The communicant may be identified by a communicant identifier received by communications agent 403b in the communication.

For example, FIG. 8A illustrates communicant message portion 812a including “text/plain” MIME type identifier 814a as a content type identifier. Communicant portion 812a may be provided to a text/plain content handler component 419b. Audio data in a voice communication may be provided to an audio content handler component 419b, and video data in a video communication may be provided to a video content handler component 419b, some or all of which may be presented to a communicant identified as a contactee in the communication.

In FIG. 4B, a content manager component 415b may operate to detect a communications request received and/or otherwise identified in a message and/or data unit, of a communications protocol, received in a communication. Content manager component 415b operating in relay execution environment 401b may receive a message in a communication with requesting execution environment 401a. Com-in component 417b in relay execution environment 401b may receive the communications request via communications protocol component 413b and network stack 411b. The communications request may be delivered to execution environment 401b of relay node 504 via network 510 based on a communicant identifier represented by communications agent 403b in relay execution environment 401b of relay node 504.

FIG. 4C, a communications protocol component 413c may operate to provide data in a data unit and/or message of a communications protocol to request-in component 412c operating in communications relay 405c in service execution environment 401c along with and/or included in web service 409c. Request-in component 412c may operate to detect a communications request received and/or otherwise identified in the data unit(s) and/or message(s) of the communications protocol. Communications protocol component 413c operating in service execution environment 401c may receive message data in one or more data units transporting the message (not shown) from requesting execution environment 401a to service execution environment 401c. The message may be delivered via one or more data units and/or messages of a communications protocol including a communicant identifier of a communicant represented by service execution environment 401c.

In still another aspect, a communications request may be received by service execution environment 401c forwarded and/or relayed from relay execution environment 401b. Web service 409c may receive a communications request from relay execution environment 401b in one or more data units and/or a message of a web protocol via network 510. Such a communications request is received by web service 409c via web protocol component 431c and application server 435c. The web service may be identified, for example, by a URL in a HTTP request sent via network 510 from relay node 504 to service node 506. Web service 409c may receive a communications request from relay execution environment 401b in a data unit and/or message of a communications protocol via network 510. Such a communications request is received by web service 409c via communications protocol component 413c and request-in component 412c. The web service may be identified, for example by a communicant identifier in an email, an instant message, and/or any data unit or message of another suitable communications protocol sent via network 510 from relay node 504 to service node 506.

In an aspect, a communicant message received via communications protocol component 413c may be processed to be presented to a user, identified as a communicant in the communication, of service execution environment 401c. In another aspect, the communicant message may be forwarded to a communications agent that represents an identified contactee, where the communications agent operates in another execution environment included in and/or provided by another node (not shown) coupled to network 510.

Exemplary resources that may be identified and/or requested via a communications request include a file, a program component, a data base record, video data, audio data, markup language, binary data, text data, an output of a service. Requested resources may be pre-existing, volatile, and/or generated in response to the request. A communications request may identify a service that when performed returns a response.

With reference to FIG. 2B, a block 214 illustrates that the method includes identifying, in processing the communications request, a service request to a web service. Accordingly, a system for processing a request via a communications agent includes means for identifying, in processing the communications request, a service request to a web service. For example, the arrangement in FIG. 3B, includes request gateway component 314 that is operable for and/or otherwise included in identifying, in processing the communications request, a service request to a web service. FIG. 4B-C illustrate request gateway components 414 as adaptations and/or analogs of request gateway component 314 in FIG. 3B. One or more request gateway components 414 operate in an execution environment 401. A system for processing a request via a communications agent includes one or more processors and logic encoded in one or more computer readable media to execute by the one or more processors that when executed is operable for and/or otherwise included in identifying, in processing the communications request, a service request to a web service. In FIG. 4B, request gateway component 414b is illustrated as a component of communications relay 405b. In FIG. 4C, request gateway component 414c is illustrated as a component of web service 409c. In an aspect, request gateway component 414b and request gateway component 414c may operate as a distributed request gateway component.

FIG. 7 illustrates a web request dataflow 708 that may include an exchange of data from a request-in component 412 to a request gateway component 414 and/or may include an exchange of data between a request gateway component and a request handler component 439. The components may operate at least partially in the same execution environment and/or may operate in different execution environments. Thus a web request dataflow may represent an exchange of data within an execution environment and/or between execution environments.

Processing a communications request may include sending a web request, based on a received communications request, by a communications relay 405. The communications relay 405 may send the web request to a web service 409. The web request may be exchanged in an execution environment that hosts some or all of the communications relay 405 and some or all of the web service. The web request may be exchanged via a network between a relay execution environment that hosts some or all of the communications relay 405 and a service execution environment that hosts some or all of the web service. A web request and/or communications request may be exchanged between a communications relay 405 and a web service via a communications protocol 413. In another aspect, a web request and/or communications request may be exchanged between a communications relay 405 and a web service via a web protocol.

In FIG. 4B, request gateway component 414b may prepare the communications request to transmit via a communications protocol to communications relay 405c, in FIG. 4C, operatively coupled to web service 409c. The communications protocol may be the same or different communications protocol by which communications relay 405b received the communications request. The communications request, suitably represented for transmission via the communications protocol, may be sent via network 510 and received via communications protocol component 413c, such as an email protocol such as version of a POP protocol. The communications request may be received by a request gateway component 414c for additional transformation, if needed. The communications request may be forwarded to a suitable command handler component 443c directly. In another aspect, a communications request may be forwarded to command handler component 443c indirectly. For example, a communications request received via communications protocol component 413c may be routed to a request handler component 439c. A request handler component may receive a communications request as a web request from a request-in component 412c, a request gateway component 414c, and/or a communications protocol component 413c when one or more are included in a service execution environment 401c, in various aspects. A request handler component 439c may include instructions that when executed process communications requests received via communications protocol component 413c.

With respect to FIG. 4C, request-in component 412c may process a communications request received via communications protocol component 413c from requesting execution environment 401a. Request-in component 412c as describe above may forward the communications request to request gateway component 414c which operates on the communications request received via communications protocol component 413c to prepare and/or otherwise transform the communications request into a form suitable for processing by the web service 409c. In particular, request gateway component 414c may prepare and/or otherwise transform a communications request into a form suitable for processing by a command handler component 443c identified based on a request identified in the communications request.

An exchange of data between a request gateway component and a web service may occur internal to an execution environment, such as an exchange between request gateway component 414c and web service 409c in FIG. 4C. Alternatively or additionally, an exchange of data between a request gateway component and a web service may occur between execution environments, such as an exchange between request gateway component 414b in relay execution environment 401b and web service 409c in service execution environment 401c in FIG. 4C. The exchange may include an exchange via a web protocol and/or communications protocol as described above.

With respect to FIG. 4B, request gateway component 414b may process a communications request by preparing and/or otherwise transforming the communications request as received via a communications protocol to a communications request in a form suitable for processing by communications request-in component 412c. Request gateway component 414b may prepare the communications request to transmit a web request including a representation of the communications request via a web protocol to web service 409c via application server 435c. A web request based on a communications request may be received by a request handler component 439c. Request handler component 439c may receive the suitably formatted request, for example, in a HTTP request via application server 435c. Request handler component 439c identifies a suitable command handler component 443c to process the request identified in the HTTP request.

FIG. 7 illustrates a service dataflow 710 that may include a dataflow internal to service execution environment 401c in FIG. 4C. In an aspect, a service dataflow may include an exchange of data between command handler component 443c and one or more components included in processing a particular request. A service dataflow may include an exchange of data between web service 409c and another node (not shown), in some aspects.

With reference to FIG. 2B, a block 216 illustrates that the method includes receiving a communications result in response to sending the service request, wherein the communications result differs from a web result generated when the web service receives the service request in a web request from a user agent operating in the requesting execution environment. Accordingly, a system for processing a request via a communications agent includes means for receiving a communications result in response to sending the service request, wherein the communications result differs from a web result generated when the web service receives the service request in a web request from a user agent operating in the requesting execution environment. For example, the arrangement in FIG. 3B, includes response-in component 316 that is operable for and/or otherwise included in receiving a communications result in response to sending the service request, wherein the communications result differs from a web result generated when the web service receives the service request in a web request from a user agent operating in the requesting execution environment. FIG. 4B-C illustrate response-in components 416 as adaptations and/or analogs of response-in component 316 in FIG. 3B. One or more response-in components 416 operate in an execution environment 401. A system for processing a request via a communications agent includes one or more processors and logic encoded in one or more computer readable media to execute by the one or more processors that when executed is operable for and/or otherwise included in receiving a communications result in response to sending the service request, wherein the communications result differs from a web result generated when the web service receives the service request in a web request from a user agent operating in the requesting execution environment. In FIG. 4B, response-in component 416b is illustrated as a component of communications relay 405b. In FIG. 4C, response-in component 416c is illustrated as a component of web service 409c. In an aspect, response-in component 416b and response-in component 416c may operate as a distributed response-in component.

Generating a communications response may include receiving a web response, from a web service included in generating a communications result, by a communications relay that received the communications request.

FIG. 7 illustrates a web response dataflow 712 that may be a data exchange via network 510 between web service 409c in FIG. 4C and communications relay 405b. A web response dataflow may include an exchange between response generator component 447c in service execution environment 401c and a response-in component 416b in relay execution environment 401b. Alternatively or additionally, a web response dataflow may include an exchange via a web protocol and/or via a communications protocol. In an aspect, data may be exchanged internal to an execution environment, such as an exchange between response generator component 447c and a response-in component 416c.

Web response dataflow 712 may include a web response exchanged in an execution environment that hosts some or all of a communications relay 405 and some or all of a web service 409. A web response dataflow may include a web response exchanged via a network between relay execution environment 401b that hosts some or all of a communications relay and a service execution environment 401c that hosts some or all of a web service. A web response dataflow may include a web response exchanged via a communications protocol. A web response dataflow may include a web response exchanged via a web protocol.

A communications result may identify a resource not identified by a web result. A web result may identify a resource not identified by a communications result. In response to receiving a communications request sent by a communications protocol, a request-in component 412 and/or request gateway component 414 may route the communications request to a web service not accessible to a user agent operating outside a service provider system's firewall(s) and/or network via a web protocol. In another aspect, a communications relay may access a web service, such as a search engine, or a portion thereof that is not accessible to a from a user agent outside of a service provider system.

For example, a retail or wholesale web service may provide a search service including an index or portion thereof that includes items for sale that are not identified when accessed via a user agent on the Internet. An index may be searched that identifies items at different prices than are available via a user agent web request. An index may identify services, accessories, and related items not identified via a user agent, sold at different prices, and/or provided with different descriptions, specifications, and/or other data. For a business user, documents may be identified based on a communicant identifier of a requesting communicant and/or based on a communicant identifier that a communications relay represents. More details may be provided for help and support for communications results than for corresponding web results. A communications result may identify a resource or “hit” not identified by the web result that identifies the same request.

Analogously, generating a communications result that differs from a web result for a particular request may include searching an index not searched and/or accessing a network service not accessed in generating a web result. For example, the knowledge of users submitting requests via communications agents may be assumed to be different than that of web users. As a result, documents, downloads, and/or other resources for a knowledge level that does not match may be filtered out and/or may be indexed and/or stored separately. Alternatively or additionally, a communications result may not include a resource identified in a web result for some requests.

In various aspects, a communications result may differ from a web result for a request based a format and/or a content type. For example, while a web result may be sent to a user agent as a HTML document a communications result may be sent as a PDF document or a spreadsheet which may be returned to a requesting communications agent as an attachment.

A communications result may differ from a web result based on a format, a language, and/or a content type of a respective communications result and web result for a request. A different privacy policy may apply for requesting users submitting a communications request via a communications agent than those that submit a web request via a user agent. Alternatively or additionally, a communications result may differ from a web result based on different security policies.

A communications result may differ from a web result based on a format. For example, a communications result may be formatted as a PDF, a TIFF, or a spreadsheet file while the service provider system may not provide these formats for a web result. Those skilled in the art will recognize that the formats identified do not constitute an exhaustive list.

In still another aspect, while a web request from a user agent may require a response via a network connection by which the web request was exchanged, a communications request received via a communications protocol may be delivered according a schedule and/or based on the occurrence of one or more specified events. A schedule may be specified by the web service, a communications relay, and/or may be specified by a user, such as the user represented by requesting communications agent. Scheduling information that at least partially specifies a schedule for sending a response may be included in a communication with a communications request.

Certain types of communications protocols do not have timeout periods in which a response is required, as opposed to HTTP requests that do have time periods in which a response must be sent and/or received. For example, a communications request submitted by email may not need to be processed immediately, the processing may operate for a longer period of time, and/or more than one search result may be generated over an extended period of time. Multiple search results for a single communications request sent by a communications agent may be generated at regular intervals or generated based on an event that may occur at irregular intervals. Such operation may be preconfigured and/or identified in and/or with a communications request. A communications result may be encrypted in a different manner than a corresponding web result.

One or more of a request-in component, a request gateway component, a search director, a search index, and a response-in component may be included in processing a communications request received via communications protocol to generate a communications result that differs from a web result generated when the request is received from a user agent.

FIG. 7 illustrates generate response (GenResp) dataflow 714 which may include a dataflow internal to service execution environment 401c in FIG. 4C and/or may include a dataflow internal to relay execution environment 401b in FIG. 4B. In an aspect, a generate response dataflow may include an exchange of data between a response-in component 416c and a response gateway component 418c in service execution environment 401c. A generate response dataflow may include an exchange of data between a response-in component 416b and a response gateway component 418b in relay execution environment 401b. In yet another aspect, a generate response dataflow may include an exchange of data between a response-in component 416c in service execution environment 401c and a response-in component 416b and/or a response gateway component 418b in relay execution environment 401b.

Generating a communications response may include receiving a web response from a web service included in generating the communications result, by a communications relay that received the communications request. The web response may be exchanged in an execution environment that hosts some or all of a communications relay and some or all of a web service. A web response includes some or all of a communications result.

In FIG. 4C, a response generator component 447c may identify and/or otherwise provide some or all of a generated communications result to response-in component 416c. Response-in component 416c may perform any filtering, sorting, and/or formatting of the communications result that was not performed by response generator 447c. Web services may vary in such functionality. Further response-in component 416c may prepare information received from response generator component 447c to identify to response gateway component 418c whether to use a web protocol or a communications protocol to send a communications response identifying some or all of the communications result.

A web response may be exchanged via a network between a relay execution environment that hosts some or all of a communications relay and a service execution environment that hosts some or all of a web service. The web response may be exchanged via a communications protocol. The web response may be exchanged via a web protocol. The exchange may occur between response-in component 416c in service execution environment and response-in component 416b. Additional web services 409 in other execution environments of the same service provider system 508 may exchange communications result data with response-in component 416b in relay execution environment 401b. Response-in component 416b may build a communications response based on one or communications result(s) from one or more web service(s) 409 of a service provider system 508.

With reference to FIG. 2B, a block 218 illustrates that the method includes sending, via the network to the requesting execution environment in response to receiving the communications request, a communications response that identifies the communications result. Accordingly, a system for processing a request via a communications agent includes means for sending, via the network to the requesting execution environment in response to receiving the communications request, a communications response that identifies the communications result. For example, the arrangement in FIG. 3B, includes response gateway component 318 that is operable for and/or otherwise included in sending, via the network to the requesting execution environment in response to receiving the communications request, a communications response that identifies the communications result. FIG. 4B-C illustrate response gateway components 418 as adaptations and/or analogs of response gateway component 318 in FIG. 3B. One or more response gateway components 418 operate in an execution environment 401. A system for processing a request via a communications agent includes one or more processors and logic encoded in one or more computer readable media to execute by the one or more processors that when executed is operable for and/or otherwise included in sending, via the network to the requesting execution environment in response to receiving the communications request, a communications response that identifies the communications result. In FIG. 4B, response gateway component 418b is illustrated as a component of communications relay 405b. In FIG. 4C, response gateway component 418c is illustrated as a component of web service 409c. In an aspect, response gateway component 418b and response gateway component 418c may operate as a distributed response gateway component.

With reference to FIG. 2A, a block 206 illustrates that the method includes receiving, by the requesting execution environment, in response to sending the communications request, a communications response that identifies a communications result, wherein the communications result differs from a web result received in a web response generated in response to a web request that identifies the first request when the web request is sent by a user agent operating in the requesting execution environment to the web service. Accordingly, a system for processing a request via a communications agent includes means for receiving, by the requesting execution environment, in response to sending the communications request, a communications response that identifies a communications result, wherein the communications result differs from a web result received in a web response generated in response to a web request that identifies the first request when the web request is sent by a user agent operating in the requesting execution environment to the web service. For example, the arrangement in FIG. 3A, includes response director component 306 that is operable for and/or otherwise included in receiving, by the requesting execution environment, in response to sending the communications request, a communications response that identifies a communications result, wherein the communications result differs from a web result received in a web response generated in response to a web request that identifies the first request when the web request is sent by a user agent operating in the requesting execution environment to the web service. FIG. 4A illustrates response director component 406a as an adaptation and/or analog of the response director component 306 in FIG. 3A. One or more response director components 406 operate in an execution environment 401. A system for processing a request via a communications agent includes one or more processors and logic encoded in one or more computer readable media to execute by the one or more processors that when executed is operable for and/or otherwise included in receiving, by the requesting execution environment, in response to sending the communications request, a communications response that identifies a communications result, wherein the communications result differs from a web result received in a web response generated in response to a web request that identifies the first request when the web request is sent by a user agent operating in the requesting execution environment to the web service.

FIG. 7 illustrates a communications response dataflow 716 that may include a data exchange via network 510 between communications relay 405b in FIG. 4B and a requesting execution environment 401a. The exchange may include an exchange between response gateway component 418b in relay execution environment 401b and a response director component 406a in requesting execution environment 401a. In another aspect, a communications response dataflow may include a data exchange via network 510 between service execution environment 401c in FIG. 4C and requesting execution environment 401a. The exchange may include an exchange between response gateway component 418c in service execution environment 401c and a response director component 406a in requesting execution environment 401a. In still another aspect, a communications response dataflow may include a data exchange via network 510 between service execution environment 401c in FIG. 4C and relay execution environment 401b. The exchange may include an exchange between response gateway component 418c in service execution environment 401c and a suitable protocol component in relay execution environment 401b included in relaying and/or forwarding data to response director component 406a in requesting execution environment 401a. A communications response dataflow may include an exchange via a web protocol and/or via a communications protocol.

Sending a communications response may include sending the communications response by a communications relay. The communications response may be sent by the communications relay in response to receiving a web response and/or other message from a web service identifying some or all of a communications result. The communications response may be sent via a web protocol. The communications response may be sent via a communications protocol. The communications response includes and/or otherwise identifies the communications result.

In FIG. 4C, response gateway component 418c may package a communications response to transmit the communications response to requesting execution environment 401a via network 510. Response gateway component 418c may send the communications response via web protocol component 431c. The communications response may be received by user agent 407a via web protocol component 431a in requesting execution environment 401a. The communications response may be sent asynchronously to user agent 407a or may be a response to a request from user agent 407a.

Response gateway component 418c may send a communications response via communications protocol component 413c addressed to the requesting communicant represented by communications agent 403a in requesting execution environment 401a. A communications response may be received by communications agent 403a via communications protocol component 413a in requesting execution environment 401a. For example, communications agent 403a may receive a link in a communications response in an email or MMS message sent from response gateway component 418c via communications protocol component 413c in service execution environment 401c.

A communications relay 405b may send the communications response based on interoperation between the communications relay 405b and web service 409c. A communications response may be received by a communications relay. Some or all of each of the communications relay and a web service may operate in an execution environment in the same service provider system. Some or all of a communications relay may operate in an execution environment in service provider system different than the service provider system in which the web service operates.

In FIG. 4B, response gateway component 418b may send a communications response via communications protocol component 413b addressed to the requesting communicant represented by communications agent 403a in requesting execution environment 401a. A communications response may be received by communications agent 403a via communications protocol component 413a in requesting execution environment 401a as described in the previous paragraph.

Receiving a communications response may include receiving the communications response in a communication along with a communicant message addressed with a communicant identifier of the requesting communicant. The communicant identifier may be included in an address space of a communications protocol. The communications protocol may be the communications protocol via which the corresponding communications request was sent by a communications agent representing the requesting user. In an aspect, the communicant identifier may be in an address space of another protocol. The communicant identifier may identify the requesting user. The communications response may be received via the same or a different communications protocol by which the communications request was sent.

Some or all of a communications result received by a requesting communications agent may be presented via an output device. If a communicant message is received with a communications response, the communicant message may be presented to the user with a representation of communications result information.

A communications request may include a communicant identifier of a copied communicant, referred to herein as a CC communicant. A communications relay may send a communications response and/or a message based on a communications response to a communications agent representing the CC communicant.

The methods illustrated in FIG. 2A-B may include additional aspects supported by various adaptations and/or analogs of the arrangement of components in FIG. 3A-B. In various aspects, performing the method illustrated in FIG. 2A-B and/or any of its extensions and/or in any of its aspects may include one or more of calling a function or method of an object, sending a message via a network; sending a message via an inter-process communication mechanism such as a pipe, a semaphore, a shared data area, and/or a queue; and/or receiving a request such as poll and responding to invoke, and sending an asynchronous message.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that operate to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more processors, or by a combination of both. The description herein of any sequence of actions is not intended to imply that the specific order described for performing that sequence must be followed.

Moreover, the methods described herein may be embodied in executable instructions stored in a non-transitory computer readable medium for use by or in connection with an instruction execution machine, system, apparatus, or device, such as a computer-based or processor-containing machine, system, apparatus, or device. As used here, a “non-transitory computer readable medium” may include one or more of any suitable media for storing the executable instructions of a computer program in one or more forms including an electronic, magnetic, optical, and electromagnetic form, such that the instruction execution machine, system, apparatus, or device may read (or fetch) the instructions from the non-transitory computer readable medium and execute the instructions for carrying out the described methods. A non-exhaustive list of conventional exemplary non-transitory computer readable media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), and a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A method comprising:
receiving, from a requesting communicant by a requesting communications agent operating in a requesting execution environment, request information that identifies a first request;
sending, by the requesting communications agent via a network in a communication, a communications request, that identifies the first request for processing by a web service; and
receiving, by the requesting execution environment, in response to sending the communications request, a communications response that identifies a communications result, wherein the communications result differs from a web result received in a web response generated in response to a web request that identifies the first request when the web request is sent by a user agent operating in the requesting execution environment to the web service,
wherein performing at least one of the preceding actions comprising the method includes execution of an instruction by a processor.

2. The method of claim 1 wherein the receiving the request information includes:
presenting a first request input UI element to the requesting user, via an output device; and
receiving the request information from the requesting user via an input, detected by an input device, that corresponds to the first request input UI element.

3. The method of claim 2 wherein the first request input UI element is included in a plurality of request input UI elements presentable by the requesting communications agent and presenting the first request input UI element includes:
selecting, based on the web service, the first request input UI element from the plurality of request input UI elements; and
presenting the first request input UI element, based on the selecting.

4. The method of claim 1 further includes automatically identifying the web service based on a communicant identifier included in the communication.

5. The method of claim 1 includes identifying a contactee communicant identifier of a contactee based a predefined template for communicant identifier and based on the request information.

6. The method of claim 1 wherein the first request includes at least one of a search request, a service access request, a data access request, a data submit request, a create request, a delete request, and a change request.

7. The method of claim 1 wherein receiving the request information includes receiving an input from the requesting communicant identifying an item, in a list, identifying the request information previously saved.

8. The method of claim 1 wherein sending the communications request includes sending the communications request in the communication along with a communicant message addressed with a contactee communicant identifier, wherein the contactee communicant identifier identifies a communicant represented by a receiving communications agent that represents the communicant.

9. The method of claim 1 wherein receiving the communications response includes receiving the communications response from the web service.

10. The method of claim 1 wherein receiving the communications response includes receiving the communications response in a communication along with a communicant message addressed with a requesting communicant identifier, wherein the requesting communicant identifier identifies the requesting communicant.

11. The method of claim 1 wherein the communications response is received by the requesting communications agent and the method further includes presenting at least a portion of the communications result by the requesting communications agent via an output device.

12. A method comprising:
receiving, in a communication by a communications relay via a network from a communications agent representing a requesting communicant and operating in a requesting execution environment, a communications request;
identifying, in processing the communications request, a service request to a web service;
receiving a communications result in response to sending the service request, wherein the communications result differs from a web result generated when the web service receives the service request in a web request from a user agent operating in the requesting execution environment; and
sending, via the network to the requesting execution environment in response to receiving the communications request, a communications response that identifies the communications result,
wherein performing at least one of the preceding actions comprising the method includes execution of an instruction by a processor.

13. The method of claim 12 wherein receiving the communications request includes:
receiving the communications request in the communication along with a communicant message addressed with a contactee communicant identifier; and f
forwarding the communicant message to be presented, via an output device, by a communications agent that represents a contactee identified by the communicant identifier.

14. The method of claim 12 wherein identifying the first request to the web service includes:
creating a web request that identifies the first request identified in the communications request; and
sending the web request to the web service.

15. The method of claim 12 wherein the communications result at least one of identifies a resource not identified by the web result, identifies a resource not identified by the communications result, and differs from the web result based on at least one of a format, a language, and a content type of the communications result and the web result respectively.

16. The method of claim 12 wherein the communications request includes a CC communicant identifier of a CC communicant identifying to the communications relay that a communications response to the communications request is to be sent to a communications agent representing the CC communicant.

17. A non-transitory computer readable medium embodying a computer program including instructions executable by a machine, for:
receiving, in a communication by a communications relay via a network from a communications agent representing a requesting communicant and operating in a requesting execution environment, a communications request;
identifying, in processing the communications request, a service request to a web service;
receiving a communications result in response to sending the service request, wherein the communications result differs from a web result generated when the web service receives the service request in a web request from a user agent operating in the requesting execution environment; and
sending, via the network to the requesting execution environment in response to receiving the communications request, a communications response that identifies the communications result.
